(19) United States
(12) Patent Application Publication
(10) Pub. No.: US 2005/0187819 A1
(43) Pub. Date: Aug. 25, 2005

(54) Method and system for measuring effectiveness of shopping cart advertisements based on purchases of advertised items

(75) Inventor: Michael Joseph Johnson, Raleigh, NC (US)

Correspondence Address: IBM CORPORATION, PO BOX 12195, DEPT YXSA, BLDG 002, RESEARCH TRIANGLE PARK, NC, 27709, US

(73) Assignee: International Business Machines Corporation, Armonk, NY (US)

(21) Appl. No.: 10/783,580

(22) Filed: Feb. 20, 2004

(51) Int. Cl. G06F 17/60

(52) U.S. Cl. 705/14

(57) ABSTRACT

Data describing advertisements displayed within a shopping cart is used within a store computer, system along with data from a process, such as barcode scanning, identifying items selected for purchase during the use of the shipping cart. The data identifying the selected items is compared with data identifying the items that have been advertised within the cart of identifying a manufacturer, supplier, or brand name that has been advertised to determine the effectiveness of the advertising and to establish an amount of money owed for displaying the advertising.

### BACKGROUND OF THE INVENTION

1. Field of the Invention

This invention relates to measuring the effectiveness of advertisements placed at the points of product selection and, more particularly, with measuring the effect of advertisements placed in shopping carts and with using such measurements to determine levels of payment for such advertisements.

2. Summary of the Background Art

A significant problem facing many companies selling products on the retail market is a lack of accurate methods for measuring the effectiveness of advertisements. A first consequence of this problem is an inability to effectively use the mathematical tools applied in other types of financial decisions to the development of a budget for advertising an individual product, with less than effective methods instead being used. A common approach is to set an advertising budget for a product as a percentage of the revenue generated by the sale of this product. However, this approach sets advertising expenditures as a result rather than a cause of sales revenue. For example, when revenues drop, it is often appropriate to increase advertising expenditures to stimulate sales; with advertising expenditures set as a percentage of revenues, this cannot be done. A second consequence of the difficulty in measuring the effectiveness of advertisements is that it is often difficult to determine which of several types of advertisements is the most effective.

Indirect measurements are often used to determine the effectiveness of advertising. For example, an artificial situation may be established with a number of people in a room viewing particular advertisements while instruments, such as cameras measuring eye movements and galvanometers measuring electrical skin responses, are used to determine the individuals levels of perception and emotional responses to particular messages and images. Surveys may be given to individuals following their exposure to advertising messages in an attempt to determine their attitudes toward products being advertised and their levels of retention of various types of information. Problems associated with such approaches include the expense of setting up artificial situations to measure individual responses and difficulties of correlating the measurements made with the actual effectiveness of advertising messages. What is needed is a direct method for measuring the effectiveness of advertisements.

The number of times a particular advertisement is made available for viewing is often used to determine the price paid for presenting the advertisement. This determination of price may be direct, with a measured number indicating the availability of the advertisement being used to establish the price to be paid for its presentation, or indirect, with data indicating the availability of an advertisements in a particular medium being made available to advertisers for use in determining whether to place advertisements in the medium, and with market forces then determining the price to be paid for such advertisements. For example, Nielsen ratings are used to determine the numbers of viewers of television programs, and various trusted methods are used for determining the circulation of newspapers and magazines. With many banner advertisements being presented over the Internet, a number of web sites displaying such advertisements count the number of user clicks accessing particular web sites. However, the quantitative data developed in these ways does not necessarily indicate that particular advertisements have actually been viewed or used in making purchasing decisions.

U.S. Pat. App. Pub. No. 2002/0184097 describes a system in which advertisers are charged according to the number of times their advertisement is presented to individual viewers of program content to which advertisements are added. The system includes a database storing a number of advertisements, an advertising selecting unit selecting at least one advertisement from the database, and a content distributing unit distributing the selected advertisement with requested content to a member viewer terminal device.

A method for basing payments for advertising services on a measurement of the effectiveness of the advertising provided is described in U.S. Pat. App. Pub. No. 2002/007190. The measurement being used in this way is the number of individuals entering a store who have received advertising information relating to the store displayed on a vehicle navigation system. After visiting the store, the customer enters the store code from a receipt into his navigation system or selects a symbol representing the store on the display screen of his navigation system. The navigation system communicates this response to the advertisement provider, which then bills the store for a fee associated with the customer's visit.

Advertisements placed at the point of selection of a product are probably among the oldest forms of marketing communications. The patent literature includes a number of descriptions of computer terminals having screens for displaying such information to be placed at points of product selection. For example, U.S. Pat. App. Pub. No. 2002/0194081 describes a kiosk, for use in a retail establishment, having capabilities of reading product bar codes and of interactive information display through a touch-sensitive display screen.

In many retail establishments, shopping carts move with customers among the various locations in which products are selected. A number of patents describe systems in screens for displaying advertisements and promotional materials on or within shopping carts. For example, U.S. Pat. No. 5,250,789 describes a shopping cart having a computer driven display system that can be used for advertising and promoting products as well as for organizing a shopping list in accordance with the locations of products in a store. The shopping list may be generated with the assistance of a cash register tape bearing the product bar codes associated with the purchased products. The system includes a bar code scanner mounted on the cart so that promotions may be issued in response to products chosen by the shopper.

U.S. Pat. No. 6,484,939 describes a console, built into the handle of a shopping cart, for the input and display of consumer product information, such as pricing. The console has a product information input device for numerical values, such as price. The apparatus includes a calculator, an output display, and, may have a video monitor providing advertising information. The console may have a bar code scanner to provide an alternate means for inputting data.

U.S. Pat. App. Pub. No. 2001/0038301 describes an advertising and promotion system including an electronic shopping cart display screen that provides wireless in-store advertising and promotions. The system includes, for example, a display unit attached to a shopping cart, a plurality of store-wide transceiver units, an audible alert component on the display unit for signaling receipt of information from the transceiver unit, a host computer for operating the advertising and promotion system, and a battery charger for powering the display unit. The display unit includes a liquid crystal display (“LCD”) panel for displaying animated graphic advertisements and other visual messages automatically exhibited in the proximity of a transceiver unit by a desired product display. The display unit may be interactive (i.e., capable of responding to user information requests and directions) or passive (i.e., only requiring (he shopper to push the earl down the aisle where it will automatically receive a signal and alert (he shopper to promotions and advertised specials).

A number of patents describe ways of making a shopping cart presenting advertising messages interact with the environment of a retail store. For example, U.S. Pat. No. 5,158,310 describes a system including a visual display unit and a transducer mounted in a shopping cart. A low-intensity ultrasonic signal emitted by a transmitter positioned at a desired location within the store is received by the transducer, which then transmits a signal to a switching circuit to activate visual indicators in the form of directional lights within the cart to direct the attention of the shopper to the location of the idem shown in the visual display unit. U.S. Pat. No. 5,264,822 describes a system for delivering audio advertising messages to shopping carts moving through a plurality of spatially defined transmission zones arranged in the aisles of a store.

U.S. Pat. No. 4,973,952 describes a shopping cart display system including a cart mounted display that is responsive to trigger signals provided by transmitters associated with a particular location. When the display receives a unique trigger signal, it displays advertising media associated with that location. In one embodiment, the display includes a sensor for determining whether the information is displayed in the presence of a consumer, and a memory for storing all trigger signals received during a given shopping trip. The stored data is transmitted to a polling transceiver located at a point of sale register for later analysis.

The patent literature includes a number of examples of shopping carts equipped so that a shopper can check out items as they are placed into the cart, with the bar codes identifying the items being scanned, and with the prices of the items being added to a list for payment after shopping is completed. For example, U.S. Pat. No. 6,435,407 describes a shopping cart including a closed mechanical bin providing for the insertion and storage of products in response to manual commands, under the control of a shopping computer. The shopping computer also controls various other systems, for optically scanning bar codes, for checking the correctness of the customer's operations, for providing a multimedia commercial message, and for the wireless exchange of data.

U.S. Pat. No. 5,418,354 describes a self service cart system provided to speed throughput at a check out counter and thus reduce space devoted to check out counters. The cart comprises a bar code scanner for acquiring a price and a description of a product, a security scanner for converting a tag from an unsecured state to a secured state, a magnetic card reader for activating the cart and a controller. The controller stores the price and description of all products in a store and keeps a running total of the price of the products scanned and placed in the cart and coordinates the various activities of the various parts of the cart system. An inventory control computer is connected to the cart's controller at the check out counter to down load the price and description of the products scanned. The products then pass through a security sensor which determines if the products are in the secured state and raises an alarm if the products are in the unsecured state.

U.S. Pat. No. 4,071,740 describes an improved automated shopping system including a first scanner releasably mounted on the shopping cart and a control panel mounted upon the shopping cart. The system additionally includes means for visual display of word and numerical entries on the control panel, means for the readings of the first scanner to appear on the visual display, means for totaling numerical data that appear on the visual display. A second scanner is located on the control panel; with the system further including means for totaling the second scanner's numerical entries so that the total, including the second scanner's other readings appears on a visual display. The system also includes a printout device located in said control panel that records and totals the numerical entries and prints them on tape.

U.S. Pat. No. 5,729,697 describes a mobile shopping cart that can automatically keep track of objects selected and carried in the cart and provide a customer using the cart information like the total price of the items carried The cart has a radio frequency cart base station with a cart antenna connected to a radio frequency cart transceiver. Various novel embodiments of the invention produce a radio frequency field within the shopping cart that is used to communicate with radio frequency tags on objects carried in the cart. The tags contain information about the respective carried object to which the tags are attached. A program function executed by the cart circuit and/or computer controls the cart transceiver to interrogate radio frequency tags within the radio frequency field, i.e. inside the cart to gain information about the carried objects. Tags on objects external to the cart are not interrogated.

### SUMMARY OF THE INVENTION

According to an aspect of the invention, a method is provided for measuring effectiveness of advertisements displayed on a shopping cart. The method includes:
displaying one or more advertisements on the shopping cart;
generating advertisement history data representing each of the advertisements;
generating a code representing each item purchased by a shopper using the shopping cart;
comparing each of the codes with said advertisement history data to determine whether an item advertised in said at least one advertisement is purchased by said shopper using said shopping cart; and
generating usage data representing each display of an advertisement for an item purchased by said shopper using said shopping cart.

While the code representing each item purchased is usually generated from data derived using a sensing device to read a machine readable element on the item, a keyboard or keypad may alternately be used to input a number. An example of such a sensing device is a barcode reader or scanner used to read a barcode label on an item.

In one version of the invention, a store is provided with one or more point-of-sale terminals, each of which has a barcode scanner. When the shopping cart is moved into proximity with one of the point-of-sale terminals, the advertisement history data is transmitted, first from the shopping cart to the point-of-sale terminal, and then from the point-of-sale terminal to a store computing system. Then, as each item being purchases is scanned at the point-of-sale terminal, a code representing its barcode is transmitted from the point-of-sale terminal to the store computer system.

In another version of the invention, each of the shopping carts is provided with a barcode scanner, which is used by the shopper to scan items being placed in the cart for purchase. As each item is scanned, a code representing its barcode is transmitted by radio from the cart to the store computer, along with the advertisement history data.

In either version of the invention, the code representing the item is compared with the advertisement history data to determine whether an item advertised in one of the advertisements presented in the shopping cart has been scanned or selected for purchase. The advertisement history data may include one or more item codes associated with each advertisement, so that these codes are compared with the code of the scanned item. Alternately, the advertisement history data may only include codes identifying the individual advertisements, with the codes representing advertised products then being determined from an advertisement data structure stored within the store computer system. A name associated with an item, such as a brand name, the name of a manufacturer, or the name of a supplier, may be advertised. Such a name is read from an item data structure within the store computer system and then compared with either a name read from the advertisement history data or from the advertisement data structure.

In another version of the invention, the store computer system controls the display of advertisements in each shopping cart, and generates and stores the advertisement history data indicating which advertisements have been displayed during the current period of use of each shopping cart.

The usage data representing each display of an advertisement for an item purchased by the shopper using the shopping cart may be used to generate an amount of money owed by each of a number of advertisers for displaying their advertisements within the shopping carts.

### BRIEF DESCRIPTION OF THE DRAWINGS

FIG. 1 is a block diagram of a system operating in accordance with a first embodiment of the invention;

FIG. 2 is a perspective view of a shopping cart and a point-of-sale terminal within the system of FIG. 1;

FIG. 3 is a block diagram of a display unit within the shopping cart of FIG. 2;

FIG. 4 is a flow chart of process steps occurring during execution of a subroutine within the display unit of FIG. 3;

FIG. 5 is a flow chart of process steps occurring during execution of a subroutine within the point-of-sale terminal within the system of FIG. 1;

FIG. 6 is a flow chart of process steps occurring execution of a subroutine within a store computer system in the system of FIG. 1;

FIG. 7 is a pictographic view of a transaction data structure within the display unit of FIG. 3;

FIG. 8 is a pictographic view of an item data structure within the store computer system of the system of FIG. 1;

FIG. 9 is a pictographic view of an advertisement data structure within the store computer system of the system of FIG. 1;

FIG. 10 is a block diagram of a system operating in accordance with a second embodiment of the invention;

FIG. 11 is a flow chart of processes occurring during execution of a subroutine in a shopping cart within the system of FIG. 10, comprising an upper portion, indicated as FIG. 11A, and a lower portion, indicated as FIG. 11B;

FIG. 12 is a flow chart of processes occurring during execution of a subroutine in a store computer system within the system of FIG. 10;

FIG. 13 is a front elevation of an alternative display unit for use within the system of FIG. 1 or the system of FIG. 10;

FIG. 14 is a block diagram of the display unit of FIG. 13 configured for use within the system of FIG. 1;

FIG. 15 is a flow chart of processes occurring during execution of a subroutine within the shopping cart of FIG. 10, equipped with the display unit of FIG. 13;

FIG. 16 is a flow chart of processes occurring during execution of a subroutine within the store computer system of FIG. 1 or FIG. 10 for printing statements to charge for advertising;

FIG. 17 is a block diagram of a system operating in accordance with an alternative version of a second embodiment of the invention;

FIG. 18 is a flow chart of processes occurring during execution of a subroutine within a store computer system of FIG. 17;

FIG. 19 is a flow chart of a subroutine alternately executing within the store computer system of FIG. 17;

FIG. 20 is a flow chart of processes occurring within the shopping cart of FIG. 10 according to an alternative version of the second embodiment of the invention, comprising an upper portion, indicated as FIG. 20A and a lower portion, indicated as FIG. 20B; and

FIG. 21 is a flow chart of processes occurring within the store computer system of FIG. 10 in accordance with the alternative version of the second embodiment of the invention.

### DETAILED DESCRIPTION OF THE INVENTION

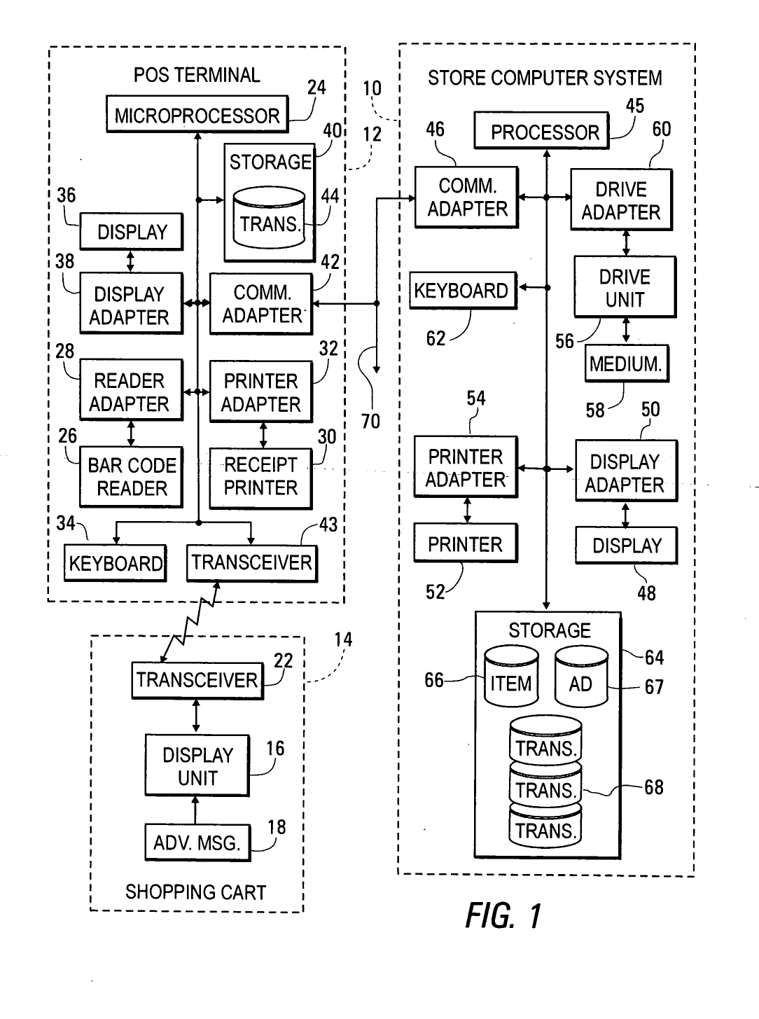

FIG. 1 is a block a block diagram of a system built in accordance with a first embodiment of the invention to include a store computer system 10, one or more point-of-sale terminals 12, and a number of shopping carts 14. The shopping cart 14 includes a display unit 16 for displaying one or more advertising messages 18 and a transceiver 20 for communicating with a transceiver 22 within the point-of-sale terminal 12 during the check out process.

The point-of-sale terminal 12 includes a microprocessor 24 and a number of conventional peripheral devices, such as a bar code reader 26 connected to the microprocessor 24 through an adapter 28 and a receipt printer 30 connected to the microprocessor 24 through a printer adapter 32, a keyboard 34 for data entry, and a display screen 36, connected to the microprocessor 24 through a display adapter 38. The point-of-sale terminal 12 also includes storage 40, storing data and program instructions for execution in the microprocessor 24, a communications adapter 42 for data communication with the store computer system 18, and a transceiver 43 for communication with the shopping cart 14. The storage 40 includes a transaction data structure 44 storing data relating to an ongoing transaction to purchase products.

The store computer system 10 includes a processor 45 and a communications adapter 46 for communicating with one or more point-of-sale terminals 24 The store computer system 10 also includes a number of conventional peripheral devices, such as a display device 48 connected with the processor 45 through a display adapter 50, a printer 52 connected with the processor 45 through a printer adapter 54, and a drive unit 56 for reading data from a removable medium 58, connected to the processor 45 through a drive adapter 60, and a keyboard 62 for data entry. The store computer system 10 also includes storage 64, storing program instructions for execution within the processor 45 and data, including an item data structure 66 storing data relating to items within the store, an advertisement data structure 67, storing data relating to the various advertisements that can be displayed within the display units 16 of a number of shopping carts 14, and a transaction data structure 68 corresponding to each of the point-of-sale terminals 12, for storing data describing the advertisements presented within a shopping cart 14 for which a check-out transaction is in progress. The computer readable medium 58 is, for example, a magnetic diskette or an optical disk, which may be written as well as read within the drive unit 58.

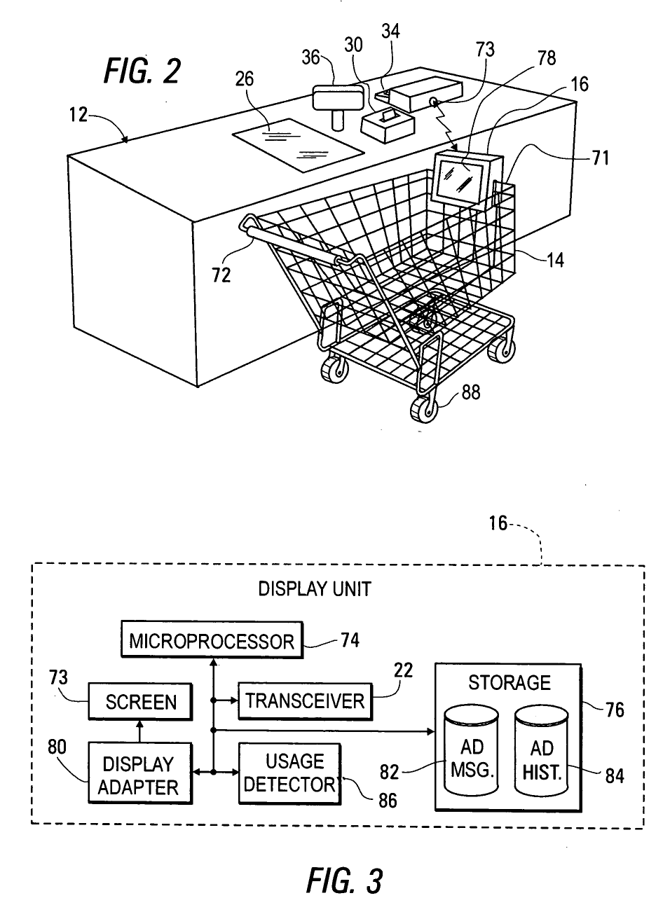

FIG. 2 is a perspective view of the point-of-sale terminal 12 and the shopping cart 14, moved into position to check out purchases and to provide for communication between the transceiver 43 within the point-of-sale terminal 12 and the transceiver 22 within the shopping cart 14. Each transceiver is understood to include both a receiver and a transmitter.

Programs for execution within the store computer system 10 are loaded into data storage 64, having been read from data stored in the computer readable medium 58 or are received for downloading in the form of computer data signals embodied on a modulated carrier wave through the communications adapter 46, which may be connected to a computer network transmission channel 70. Programs for execution within the microprocessor 24 of the point-of-sale terminal 12 may be transmitted in the form of a computer signal on a modulated carrier wave transmitted from the communication adapter 46 of the store computer system 10 to the communication adapter 42 of the point-of-sale terminal 12.

Referring to FIGS. 1 and 2, the point-of-sale terminal 12 includes a transducer 70 through which a beacon signal is emitted to be detected by the transceiver 22 within the shopping cart 14 is brought into position adjacent the point-of-sale terminal 12. When this beacon signal is detected by the transceiver 22 within the shopping cart 14, the shopping cart 14 responds by transmitting data regarding advertisements that have been displayed within the display unit 16. Preferably, the transceivers 22, 43 are arranged so that communications are established between the shopping cart 14 and the point-of-sale terminal 12 only when the shopping cart 14 is moved into place adjacent the point-of-sale terminal 14, with the resulting communications not effecting other shopping carts or other point-of-sale terminals. This is accomplished, for example, by modulating an infrared light beam with a data signal to provide line-of-sight communication over a short distance.

The process described above is an example of a number of processes, known to those skilled in the art of communications, that may be used transmit information identifying the shopping cart 14 to the point-of-ale terminal 12. For example, a reader at the point-of-sale terminal 12 might read a barcode label attached to the shopping cart 14, or the point-of-sale terminal 12 might identify the shopping cart 14 by means of a identification chip producing an output signal at a radio frequency.

While the display unit 16 is shown as being attached to an end 71 of the cart 14 that is opposite the handle 72. The advantage of this placement is that the display unit-16 interferes least with the placement of items in the shopping cart. The disadvantage is that the display unit is far enough from the shopper pushing the cart that images displayed on the screen 73 of the display unit 16 must be quite large to be read. Alternately, the display unit 16 may be placed near the handle 72.

FIG. 3 is a block diagram of the display unit 16 attached within the shopping cart 14. The display unit 16 includes a microprocessor 74, storage 76 storing data and instructions for execution within the microprocessor 74, a display screen 73, displaying images generated from an electrical signal, which is, for example, an LCD (liquid crystal display), driven through a display adapter 80, and the transceiver 22. The transceiver 22 transmits and receives signals through a transducer (not shown) in a line of sight relationship with the transducer 70 of the point-of-sale terminal 12. The storage 26 includes an advertising message data structure 82, providing the content of advertising messages displayed on the display screen 73, and an advertising history data structure 84 storing a record of the advertising messages that have been displayed during an individual use of the shopping cart 14.

The shopping cart 14 is typically returned to a cart storage area after a sale transaction has been completed, to be picked up from the storage area by another shopper beginning another period of individual use of the shopping cart 14 by a shopper. While the sopping cart is generally then used by the shopper to accumulate items for purchase, sometimes the shopping cart may be abandoned within the store or returned to the cart storage area without selecting a purchase. It is desirable to keep track of the advertisements that are presented during each period of individual use of the shopping cart so that a record of such advertisements can be compared with the items purchased during the period of individual use of the shopping cart to determine the effectiveness of particular advertisements and to form a basis for charging for the presentation of the advertisements. It is further desirable, in order to reduce the drain on batteries operating electronic functions of the display unit 16, to stop the presentation of advertising messages during a period with the shopping cart 14 is not being used by a shopper. To this end, a usage detector 86 is preferably added to the shopping cart 14, to provide a signal indicating that the shopping cart 14 is being used. For example, the usage detector 86 may be a motion sensor within the display unit 16, providing an output signal when the shopping cart 14 is moved. Alternately, an emitter driven by one of the wheels 88 of the shopping cart 14, may be electrically connected to the display unit 16, providing a series of pulses as the cart 14 is moved. In a further alternative, a mechanism sensing the placement of items in the shopping cart 14 is used as an indication of continued usage of the cart 14.

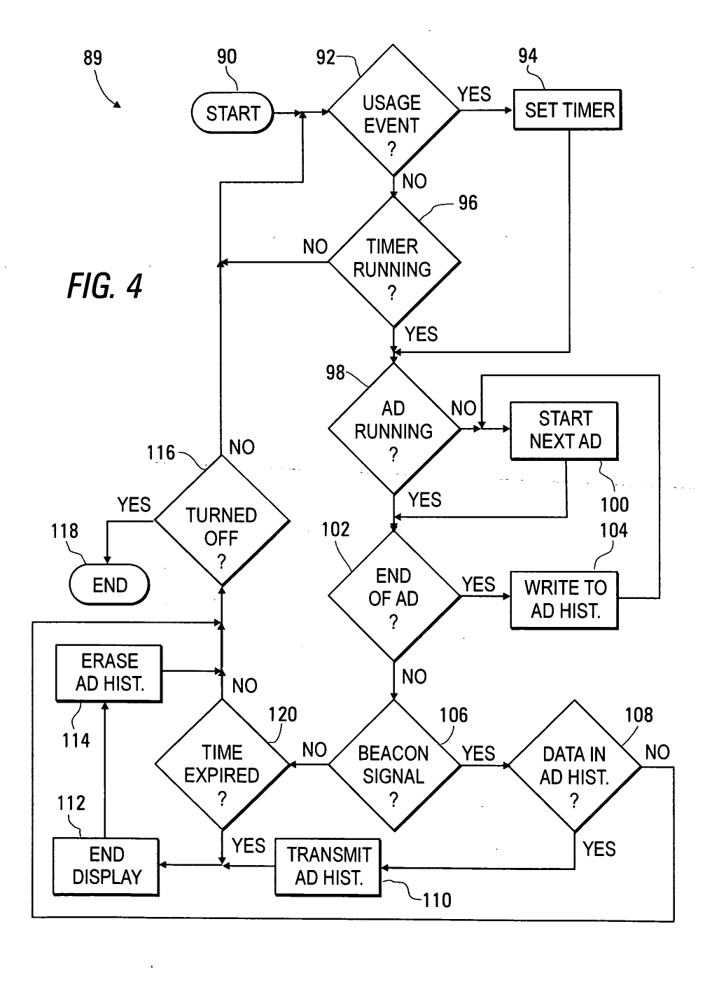

FIG. 4 is a flow chart of process steps occurring within the display unit 16 of the shopping cart 14, under control of the microprocessor 74 during the execution of a subroutine 89. After starting in step 90, for example, when the display unit 16 is turned on and when the microprocessor 74 is allowed to complete an initialization subroutine, the subroutine 89 proceeds to step 92, in which a determination is made of whether a usage event has occurred, as represented by a signal from the usage detector 86. For example, the usage of the cart 14 is detected as movement of the cart. If such an event has occurred, a timer is set in step 94. Alternative, the usage event may be the manual operation of a switch on the cart, with such an operation being provided by the shipper or by a store employee offering the cart to the shipper. The timer may be an electronic device, an electromechanical device, or a subroutine counting clock pulses. The timer is preferably set to run long enough that if the shopper leaves the cart 14 still while selecting an item or while talking to someone, the timer will continue running until the cart is again moved. If it is determined in step 96 that a usage event has not occurred, the subroutine 89 proceeds to step 96, in which a determination is made of whether the timer is running. If the timer is not running, the cart 14 is apparently sitting in storage, so the subroutine 89 returns to step 92, going into a loop until a usage event is detected in step 92.

On the other hand, if it is determined in step 96 that the timer is running, the subroutine 89 proceeds to step 98, in which a determination is made of whether an advertisement is running. If it is not, the next advertisement stored in the advertisement message data structure 82 is started in step 100. Then, in step 102, a determination is made of whether the end of an advertisement has been reached, if it has, data representing the advertisement that has just been completed is written to the advertisement history data structure 84 in step 104, and the subroutine 89 goes to step 100 to start the next advertisement.

The advertisement content, which is stored in computer readable form in the advertisement message data structure 82, consists of still images, moving images, stored, for example, in MPEG format, or a combination of still images and moving images. Data stored within the advertisement message data structure 82 controls the length of time a still image is presented and provides for the sequential presentation of still and moving images. Preferably, the images run continuously, with the first advertising message being started after the last such message is finished. Audio content may also be included if the display unit 16 is equipped with a speaker. Additionally, the presentation of images may be made interactive, with buttons being added to the display unit for controlling portion of the display process.

After it has been determined in step 102 that an advertisement is running without having reached its end, the subroutine 89 proceeds to step 106, in which it is determined whether a beacon signal is present. As described above in reference to FIG. 2, a beacon signal is emitted by the point-of-sale terminal 12 to be detected by the transceiver 22 within the shopping cart 14 only when the cart 14 has been brought into place beside the point-of-sale terminal 12 to begin the check-out process. Thus, if it is determined in step 106 that the beacon signal is present, the subroutine 89 proceeds to step 108, in which a determination is made of whether data is stored in the advertisement history data structure 84. If such data is present, it is transmitted in step 110 to the point-of-sale terminal 12 through the transceiver 22 within the display unit 16. Then, the process of displaying advertisements is ended in step 112, and data within the advertisement history data structure 84 is erased in step 114.

The display unit 10 is preferably provided with a means to be turned off by store personnel. For example, the display unit 10 may be turned off at the end of a business day, with a battery within the display unit 10 being connected to a power source for recharging. Thus, after the advertisement history data structure has been erased in step 114, it is determined in step 116 whether the display unit has been turned off. If it has, execution of the program ends in step 118. If it has not, the subroutine 89 returns to step 92.

Since the process of checking out items at the point-of-sale terminal 12 takes some time, it is repeatedly determined in step 106 that a beacon signal is present. However, after the first such determination, the content of the advertisement history data structure 84 is erased in step 114. After this occurs, the determination in step 108 that data is not present in this data structure 84 causes the subroutine 89 to proceed to step 116 without attempting to transmit data in step 110.

After a determination is made in step 106 that the beacon signal is not present, the subroutine 89 proceeds to step 120, in which a determination is made of whether time has expired in the timer last set in step 94. If time has not expired, the subroutine 89 proceeds to step 116, in which a further determination is made of whether the display unit 16 has been turned off. If it has been turned off, the program ends in step 118. If it has not been turned off, the program continues operation, returning to step 92. On the other hand, if it is determined in step 120 that time has expired, the assumption is made that the cart has been left motionless or otherwise unused for such a long time that it must have been abandoned. Therefore, the display of advertising messages is ended in step 112 and the content of the advertisement history data structure is erased in step 114 before returning to steps 116 and 92.

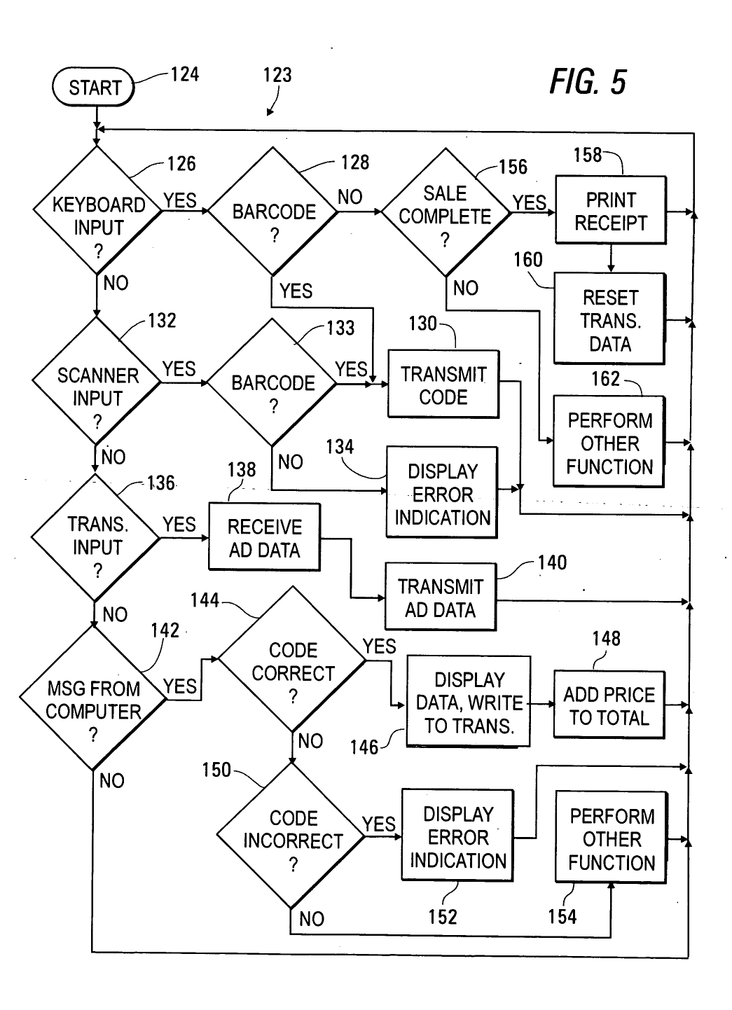

FIG. 5 is a flow chart of processes occurring within the point-of-sale terminal 12 under control of the microprocessor 24 executing a subroutine 123. After starting in step 124, the subroutine 123 proceeds to determine if inputs have been received from various peripheral devices. For example, such inputs may conventionally be determined to be present by handling various interrupts. First, in step 126, a determination is made of whether an input from the keyboard 34 is available, being stored, for example, within a keyboard buffer of the terminal 12. If it is, a determination is then made in step 128 of whether it represents a Uniform Product Code, or barcode, of an item to be sold. It is understood that the process of scanning a barcode means that the item having the barcode has been selected by the shopper for purchase. Such codes can be provided as input through the keyboard 34 of the point-of-sale terminal 12 as well as through the barcode reader 26, with the keyboard 24 being used in the event that a barcode label cannot be read in the reader 26. If it does represent such a code, the code is transmitted in step 130 to the store computer system 10.

After determining in step 126 that a keyboard input has not occurred, the subroutine 123 proceeds to step 132, in which a determination is made of whether an input has been received from the barcode reader or scanner 26. If such an input has been received, a further determination is made of whether the input from the barcode reader 26 represents a barcode. If it does, the subroutine 123 proceeds to step 130 to transmit the code to the store computer system 10 through the communications adapter 42. If it does not represent a barcode, an error indication, indicating a misread, is presented in step 134. Such an error indication may be made by illuminating a red indicator light, with a green light being used to indicate a successful attempt to read a barcode.

After determining in step 132 that an input has not been received from the barcode reader 26, the subroutine 123 proceeds to step 136, in which a determination is made of whether an input is being received from the transceiver 43. If such an input is being received, advertising history data is received in step 138 from a shopping cart 14 currently involved in the check-out process, with the data being transmitted in step 110, as described above in reference to FIG. 4. Then, in step 140, this data is transmitted through the communication adapter 42 to the store computer system 10.

After determining in step 136 that an input is not being received from the transceiver, the subroutine 123 proceeds to step 142, in which it is determined whether a message is being received through the communication adapter 42 from the store computer system 10. If such a message is being received, it is determined in step 144 whether the message indicates that the last code representing a barcode, sent from the point-of-sale terminal 12 to the store computer system 10, is a code stored within the item data structure of the store computer 10 as representing a valid item to be sold. If it is such a code, data describing the item and its price is returned to the point-of-sale terminal 12 from the store computer 10, and this date is displayed in step 146 on the display unit 36 of the point-of-sale terminal 12. This data is also written to the transaction data structure 44 to become part of the transaction presently occurring within the check out process. Then, in step 148 the price is added to a total being generated and also stored within the transaction data structure 44.

If it is determined in step 144 that the input received from the store computer 10 does not acknowledge that a correct code has been transmitted from the point-of-sale terminal 12, a further determination is made in step 150 of whether this input indicates that a code sent from the terminal 12 does not represent a code for a valid item to be sold. If such an indication has been received, an error indication is displayed in step 152, so that an item can be rescanned within the barcode reader 26 or so that a barcode number can be entered using the keyboard 34. Otherwise, the subroutine 123 proceeds to step 154 to perform another function as directed by the store computer system 10.

In this way, data representing each item having been checked out is accumulated within transaction data structure. Therefore, if it is determined in step 128 that the keyboard input does not represent a barcode, the subroutine 123 proceeds to step 156, in which a determination is made of whether the keyboard input has been an indication that the sale is complete, i.e. that all of the items have been checked out. For example, one key on the keyboard 34 may be used to provide this indication. If it is determined in step 132 that the keyboard input indicates that the sale is complete, the subroutine 123 proceeds to print a sales receipt within the receipt printer 30 in step 158. Then, in step 160, the data within the transaction data structure 44 is erased, making this data structure 44 ready for the next transaction. For financial tracking and inventory control, data from many such transactions may be further stored in another data structure, either within the point-of-sale terminal 12 or in the store computer system 10. On the other hand, if it is determined in step 156 that the data from the keyboard does not provide an indication that the sale is complete, the subroutine 123 proceeds to step 162 to perform another function specified by the keyboard data. For example, such another function may include ending execution of the program of FIG. 5 to begin the process of shutting off the point-of-sale terminal 12.

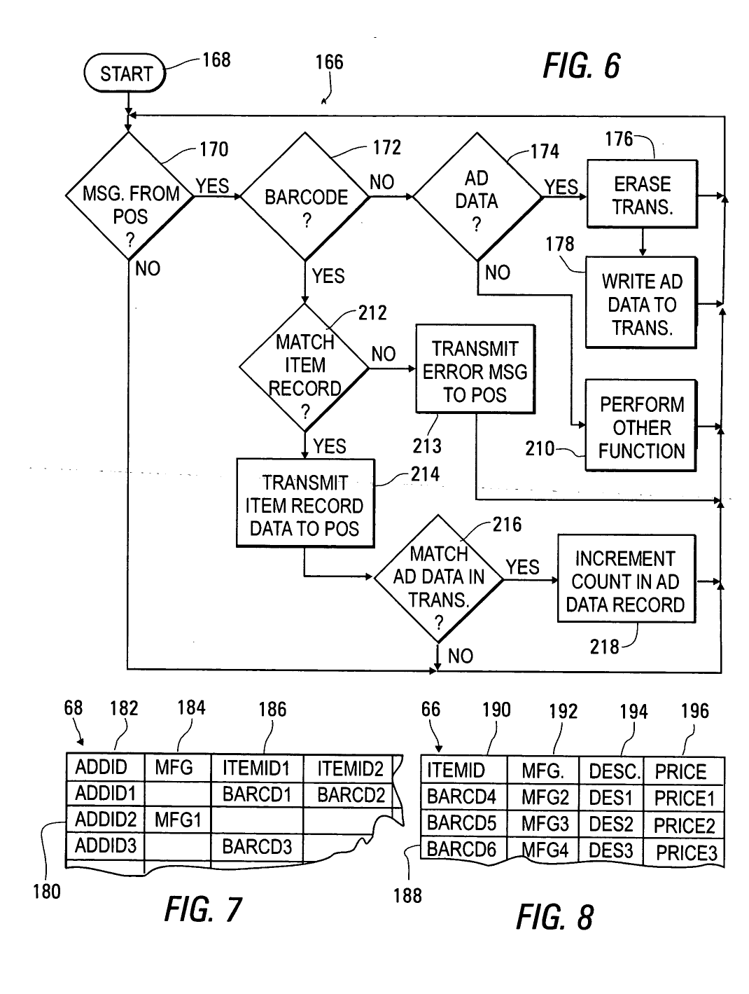

FIG. 6 is a flow chart of a subroutine 166 occurring within the store computer system 10, with the processor 45 executing instructions read from storage 64, in order to respond to messages received from one of several point-of-sale terminals 12 and further in order to develop a data structure indicating the effectiveness of advertisements displayed in the display units 16 of shopping carts 18 in terms of generating sales.

After starting in step 168, this subroutine 166 proceeds to step 170 to determine if a message is being received from one of the point-of-sale terminals. If such a message is not being received, the subroutine returns to continue waiting for a message to be received. When such a message is received, a further determination is made in step 172 of whether the message is data describing a barcode, sent in step 130 or in step 140, as described above in reference to FIG. 5. If the message is determined not to be barcode data, a further determination is made in step 174 of whether the message is data regarding advertisements that have been displayed in a shopping cart 14, with which the process of checking out items is now being started at the particular point-of-sale terminal 12. Such a transmission is understood to occur in step 140, as described above in reference to FIG. 3, following movement of the cart 14 into a position adjacent the point-of-sale terminal, as shown in FIG. 2, before items are checked out. Since such a transmission of data is thus understood to occur at the beginning of a new transaction at the point-of-sale terminal 12, the content of the transaction data structure 68 associated with the terminal 12 sending the message is erased in step 176, with advertisement data transmitted within the message being then stored in this data structure 68 in step 178. In this way, data identifying each of the advertisements displayed in the shopping cart 14 during the use of the shopping cart before the check out process now occurring at the point-of-sale terminal 12 is written to the transaction data structure 68 associated with the terminal 12.

FIG. 7 is a pictographic view of the transaction data structure 68, which includes a data record 180 corresponding to each advertisement displayed on the cart 14 from which items are currently being checked out at the point-of-sale terminal 12 associated with the particular data structure 68. Since these data records 180 are derived from data stored within the advertisement history data structure 84 within the display unit 16 of the shopping cart 14, which is erased in step 114 following the expiration of time, indicating that the cart 14 has apparently been abandoned, and during the check-out process after transmitting data to one of the point-of-sale terminals 12, as explained above in reference to FIG. 3, the data stored in the data records 108 is understood only to represent those advertisements displayed in a session ending with the presently occurring check-out process.

Each transaction data structure 68 includes an identifier data field 182 for storing an alphanumeric identifier of an advertisement, a manufacturer data field 184 identifying a name, such as the name of the manufacturer, supplier, or brand being advertised in the advertisement associated with the data record 180, and a number of item data fields 186 containing codes, such as barcode data, representing one or more items being advertised in the advertisement of the data record 180. If all of the data stored within a data record 180 is stored in an associated record in the advertisement history data structure 84 of the shopping cart display unit 16, to be subsequently stored in a data record within the transaction data structure 44 of the point-of-sale terminal 12, and then to be transmitted to the store computer system 10, this data is written directly to the transaction data storage 68. Alternately, the advertisement history data structure 84 of the shopping cart display unit 16 may store only the advertisement identifiers written to the identifier data field 182, with the remaining data being read from the advertisement data structure 67 in data records associated with the individual identifiers and written to the transaction data structure 68 during step 160.

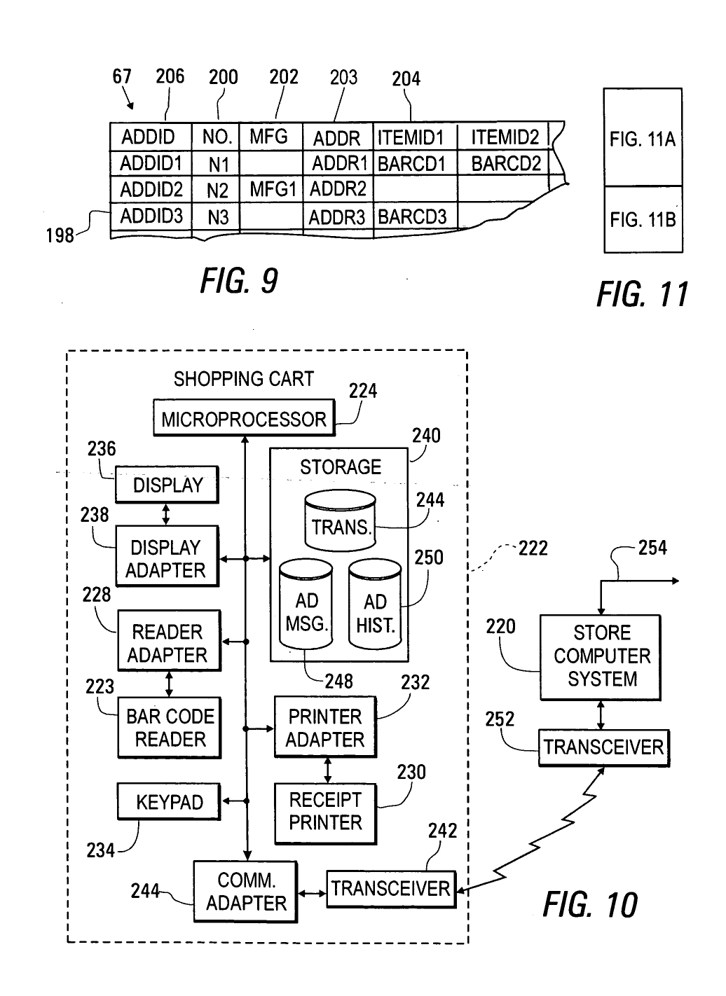

FIG. 8 is a pictographic view of the item data structure 66, stored within the store computer system 10, which includes a data record for each item to be sold within the store that can be identified by barcode data. This item data structure 88 includes an identifier data field 190, in which data representing the barcode identifying the item is stored, a manufacturer data field 192 in which data identifying a name, such as a manufacturer, supplier, or brand of the item is stored, a description data field 194 in which a description of the item is stored, and a price data field 196 in which a price of the item is stored. The description of the item includes data, such as the size or weight of the item and its type, that is used to describe the item on a printed receipt.

FIG. 9 is a pictographic view of the advertisement data structure 67, in which each data record 198 stores data corresponding to an advertisement that can be presented within the shopping carts 14 in the store. The data fields of the advertisement data structure are the same as the data fields of the transaction data structure 68, which have been explained above in reference to FIG. 7, except that a counting data field 200 has been added to the advertisement data structure 67 to store a number representing the number of times that the advertisement has been presented during a period of usage of a shopping cart 14 in which an item being advertised was subsequently sold, or in which an item of a manufacturer, supplier, or brand being advertised was then sold. Some of the data records 198 include an entry in the manufacturer data field 202, representing the manufacturer, supplier, or brand being advertised. If the store computer system 10 is to be used to generate statements for advertising services, the advertising data structure includes an address data field 203 storing addresses to which such statements are to be sent. Some data records 198 include one or more entries in the item data fields 204, representing barcodes of the items being advertised. Each of the advertisements is identified by an alphanumeric identifier within the identifier data field 206, corresponding to an identifier of the same advertisement in the identifier data field 182 of each transaction data structure.

Referring again to FIG. 6, if it is determined in step 174 that the message is not such advertising data, the subroutine 166 proceeds to step 210 to perform another function requested by the message from the point-of-sale terminal 12. On the other hand, if it is determined in step 172 that the message is in fact barcode data, the subroutine proceeds to step 212, in which a determination is made of whether the barcode data matches an entry within the identifier data field 190 of the item data structure 66 (shown in FIG. 8), indicating that the barcode data is for an item represented by a data record 188 within the item data structure 66. If it does not match such an entry, an error message is returned to the point-of-sale terminal 12, in step 213. Such an error message is received by the terminal 12 in step 142, as described above in reference to FIG. 5. If the barcode data matches such an entry, data from the corresponding data record 188, in which the barcode data is found, is transmitted, in step 214 to the point-of-sale terminal 12 sending the message. This data, which is additionally received in step 142, includes a description of the item represented by the barcode and the price of the item, to be used in the preparation of a receipt.

After data is transmitted to the point-of-sale terminal 12 in step 214, the subroutine 166 proceeds to step 216, in which an additional determination is made of whether data associated with the item identified by the barcode data matches data associated with one of the advertisements for which data is stored in the transaction data structure associated with the point-of-sale terminal 12 sending the message. Preferably, this process of step 216 includes both determining whether the barcode data matches the barcode data stored in one of the item data fields 186 of the transaction data structure 68 (shown in FIG. 7) and determining whether the entry from the manufacturer data field 192 of data record 188 within the item data structure 66 (shown in FIG. 8) in which the barcode data is found matches an entry in the manufacturer data field 184 within the transaction data structure 68. If such a match is found, the advertisement identifier from the identifier data field 182 of the data record 180 within the transaction data structure 68 in which the match is found is used to identify a data record 198 within the advertisement data structure 67 (shown in FIG. 9). Then, in step 218, a value of one is added to the number stored in the number field 200 of this data record 198.

FIG. 10 is a block diagram of a system operating in accordance with a second embodiment of the invention; including a store computer system 220 and a shopping cart 222, which is understood to be representative of a number of similar carts within a retail store. The shopping cart 222 includes a barcode reader 223, which is used by the shopper to scan items as they are placed into the cart 222, saving time by eliminating a need to scan the items at a point-of-sale terminal. It is understood that the process of scanning an item in the barcode reader 223 means that the shopper has selected the item for purchase.

The shopping cart 222 additionally includes a microprocessor 224, to which the bar code reader 223 is connected through an adapter 228, a receipt printer 230 connected to the microprocessor 224 through a printer adapter 232, a keypad 234, which is used, for example, to enter barcode numbers that cannot be read by the barcode reader 263, and a display screen 236, connected to the microprocessor 224 through a display adapter 238. The display screen 236 is used to display advertisements under control of the microprocessor 224 and may also be used to display messages relating to the use of the barcode reader 223 to check out items. The shopping cart 222 also includes storage 240, storing data and program instructions for execution in the microprocessor 224, and a transceiver 242 for communication with the store computer system 220, connected to the microprocessor 224 through a communications adapter 244. The storage 240 includes a transaction data structure 246, storing data relating to an ongoing transaction to purchase products, an advertising message data structure 248, providing the content of advertising messages displayed on the display screen 236, and an advertising history data structure 250 storing a record of the advertising messages that have been displayed during an individual use of the shopping cart 222.

The store computer system 220 is similar to the store computer system 10, as described above in reference to FIG. 1, except that storage within the store computer system 220 does not include the transaction data structures 68. Thus elements within the store computer system 220 will be described with the reference numerals to the corresponding elements within the store computer system 10. A communications adapter 46 within the store computer system 220 is connected to a transceiver 252 for communication with the shopping cart 222. The store computer system 220 may additionally be connected to a computer network channel 254. The transceivers 242, 252 are preferably part of a communication system configured in a manner well known to those skilled in the art of radio frequency communications allowing communications between the store computer system 220 and a number of shopping carts 222 within the store.

Referring to FIGS. 1 and 10, storage 230 constitutes a computer readable medium within which program instructions are stored for execution within the microprocessor 224. Such instructions may be read from the computer readable medium 48 within the store computer system 220, or from the computer network channel 254 in the form of a computer data signal embodied on a modulated carrier wave, and transmitted in the form of a computer data signal embodied on a modulated carrier wave between the computer system 220 and the shopping cart 222.

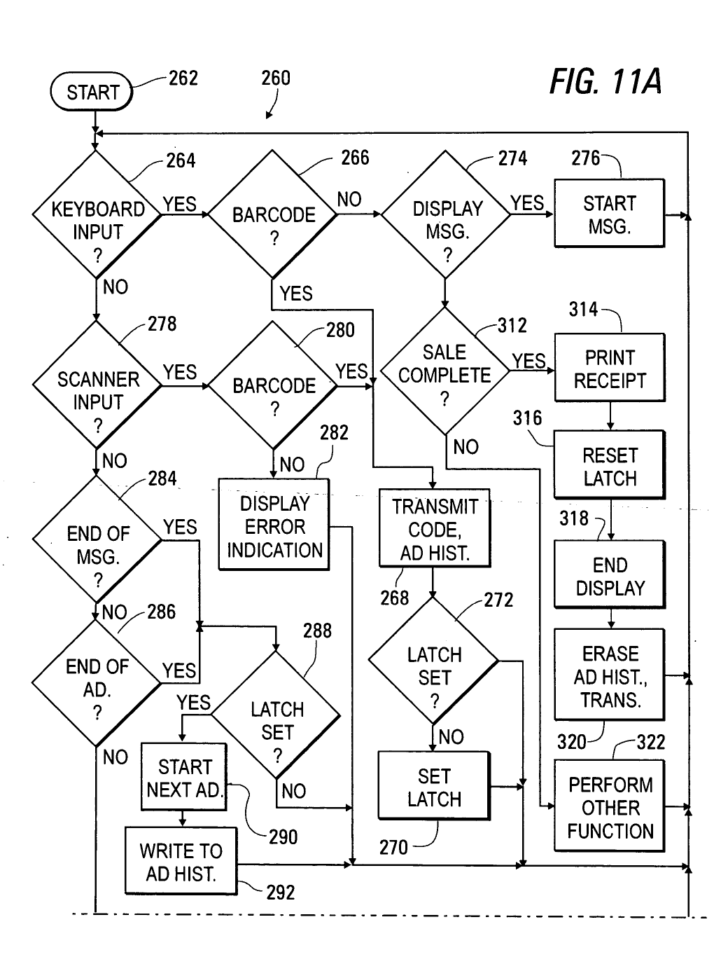

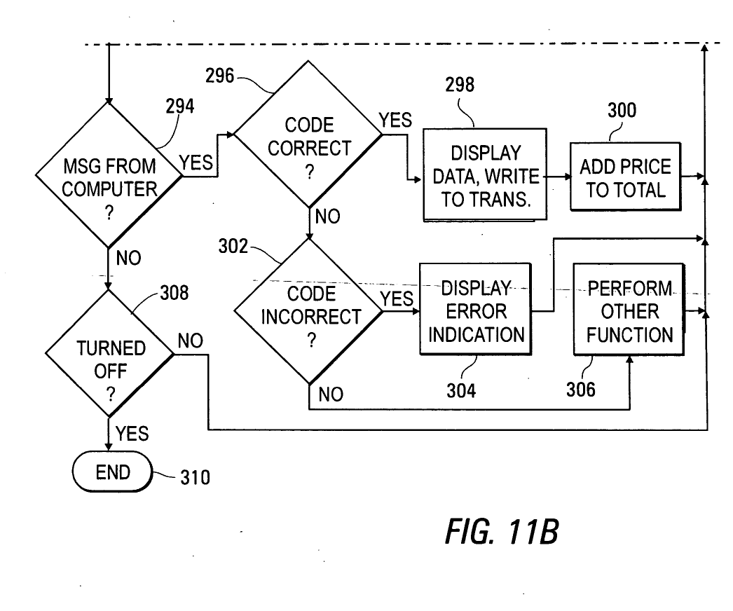

FIG. 11 is a flow chart of processes occurring within the shopping cart 222 during execution of a subroutine 260 within the microprocessor 224. FIG. 11 includes an upper portion, indicated as FIG. 11A, and a lower portion, indicated as FIG. 11B. The subroutine 260 provides for the presentation of advertisements through the display screen 230 and for the communication of data concerning the advertisements that have been presented to the store computer system 220 along with data derived from reading barcodes through the barcode reader 223.

After starting in step 262, for example, when the electronic devices in the shopping cart 222 are turned on and when the microprocessor 224 is allowed to complete an initialization subroutine, the subroutine 260 proceeds to step 264, in which a determination is made of whether an input has occurred through the keypad 234. If such an input has occurred, an additional determination is made in step 266 of whether the keyboard input forms data representing a barcode (or Uniform Product Code) on an item being sold. In this regard, the keypad 234 is used to input barcode data that cannot be read with the barcode reader 223. If the keypad input is determined to be barcode data, data representing the barcode is transmitted to the store computer system 220 through the transceiver 242 in step 268. Preferably, data from the advertisement history file 250 is also transmitted during step 268, identifying each of the advertisements that has been displayed during this usage of the shopping cart 222.

According to a preferred version of the invention, a latch is set to indicate that an individual usage of the cart 222 has begun and reset to indicate that such a usage of the cart 222 has been completed. Thus, the latch is set in step 270 with the first transmission of barcode data in step 268, following a determination in step 272 that the latch is not set. Alternately, the transmission of data in step 268 may be followed by an attempt to set the latch regardless of whether it is already set. The latch may be an electromechanical device, an electronic device, or a register in which a bit is set and cleared.

Preferably, data is displayed on the display screen 236 in an interactive manner, with certain inputs from the keypad 234 being used to start or otherwise control the display process. Thus, when it is determined in step 266 that a keypad input is not barcode data, the subroutine 260 proceeds to step 274, in which a further determination is made of whether the keypad input is a request to display a message. If it is, the process of displaying the message on the display screen 236 is begun in step 276. For example, the a visual presentation concerting how to use various features of the shopping cart 222 can be presented in this way.

When it is determined in step 264 that a keypad input has not occurred, an additional determination is made in step 278 of whether an input from the barcode reader 223 (scanner) has occurred. If it has, it is then determined in step 280 whether the data generated represents a barcode. If it does, the subroutine 268 to transmit the code to the store computer system 220 and to set the latch if it is not already set. If the input does not match barcode data, an error indication is displayed in step 282. Such an indication may be presented as a message on the display screen 236 or through the illumination of an indicator light on a control panel associated with the barcode reader 223.

When it is determined in step 278 that an input from the barcode reader 223 has not occurred, the subroutine 260 proceeds to determine if an end of a message or advertisement has occurred. Thus, in step 284, a determination is made of whether the end of a message started in step 276 has occurred. If it has not, a further determination is then made in step 286 of whether an end of an advertisement being displayed has been reached. If either type of end has been reached, a further determination is made in step 288 of whether the latch has been set, indicating that the shopping cart 222 is still being used by a shopper. If it is set, the display of next advertisement is started in step 290, and data describing the new advertisement is written to the advertisement history data structure 250 in step 292.

When it is determined in step 286 that the end of the display of an advertisement has not been reached, it is then determined in step 294 whether a message has been received through the transceiver 242 from the store computer system 220. If it has, a further determination is made in step 296 of whether the message indicates that the data last transmitted from the shopping cart 222 represents a valid barcode for an item to be sold within the store. If it has, data received within the message describing the item, including its price, is displayed on the display screen 236 and written to the transaction data structure 244 in step 298. Then, in step 300, the price of the item is added to a total also stored within the transaction data structure 244. On the other hand, when it is determined in step 296 that the message does not indicate that the data last transmitted represents a valid barcode for an item to be sold within the store, a further determination is made in step 302 of whether the message indicates that the message indicates such a code is incorrect barcode data. If it does, an error indication is then displayed in step 306. Otherwise, the shopping cart 222 preferably performs another function according to the message from the store computer system 220 in step 306.

The shopping cart 222 is preferably provided with a means to be turned off by store personnel. For example, the cart 222 may be turned off at the end of a business day, with a battery within the cart 222 being connected to a power source for recharging. Thus, after a determination is made in step 294 that a message has not been received from the store computer system 220, it is determined in step 308 whether the cart 222 has been turned off. If it has, execution of the program ends in step 310. If it has not, the subroutine 260 returns to step 264.

The keypad 234 is preferably additionally used to indicate that the shopping process has been completed, with a determination in step 274 that a keypad input is not a request to start the display of a message being followed by an additional determination in step 312 of whether the keypad input is an indication that the sale is complete. If it is, a sales receipt is printed in step 314, using information stored in the transaction data structure 244, including prices of items and a price total. The latch is then reset in step 316, the process of displaying an advertisement is ended in step 318, and the advertisement history structure 250 and the transaction file 244 are erased in step 326. If it is determined in step 312 that the keypad input is not an indication that the sale is complete, the system performs another function, in response to a keypad command, in step 322.

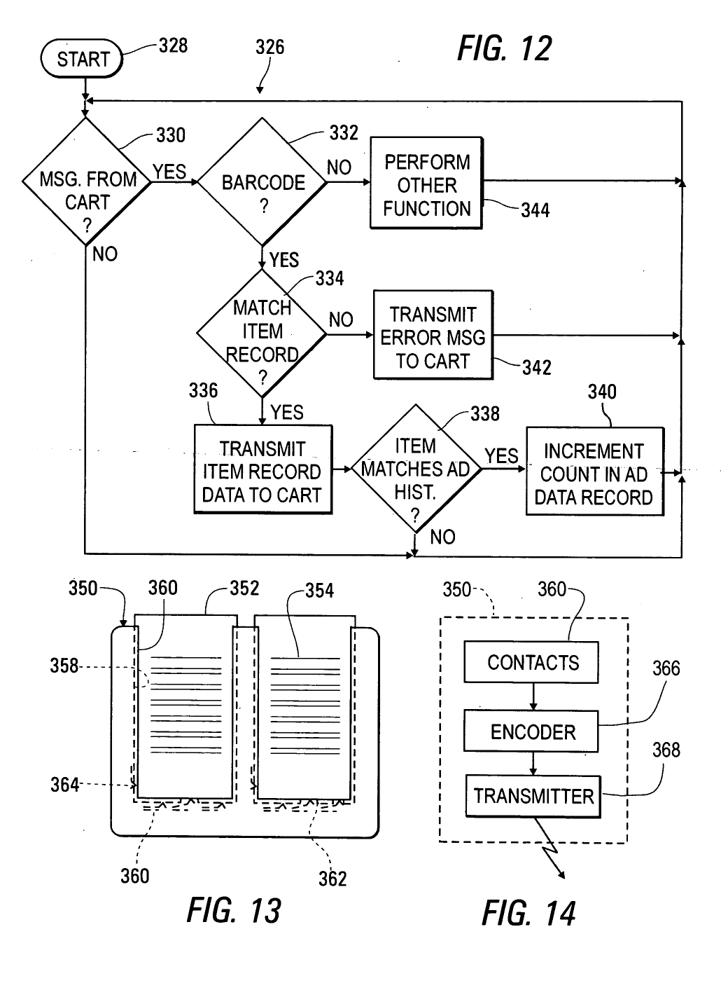

FIG. 12 is a flow chart of processes occurring within the store computer system 220 during execution of a subroutine 326, controlling communications with a number of shopping carts 222 and generating data indicating a number of times that each of a number of advertisements was displayed in any cart before a subject of the advertisements was purchased using the cart.

Referring to FIGS. 8 and 12, after starting in step 328, the subroutine 326 proceeds to step 330, in which it is determined whether a message has been received from a cart 222. When it is determined that such a message has been received, the subroutine 326 proceeds to step 332, in which a further determination is made of whether the message is barcode data, transmitted from the cart 222 in step 268, as explained above in reference to FIG. 11. If it is, a determination is made in step 334 of whether the barcode data matches data stored in the identifier data field 130 of the item data structure 66. If such a match is found, data from the data record 188 in which the barcode data is matched, within the manufacturer data field 192, the description data field 194, and the price data field 196 is returned to the cart 222 in step 336, for display and use in preparing a sales receipt. Then, in step 338, data from the advertisement history data structure 250 of the shopping cart 222, transmitted to the store computer system along with the barcode data in step 268, is compared with the barcode data, and, preferably, additionally with the data from the manufacturer data field 192, to determine whether the item identified by the barcode matches one of the advertisements that has been displayed in the shopping cart 222. If it does, within each data record 198 of the advertisement data structure 87, shown in FIG. 9, for an advertisement found to match data associated with the item, a value of one is added to the numeric value stored within the counting data field 200 in step 340.

The advertisement history data transmitted from the shopping cart 222 to the store computer system 200 may include manufacturer information and/or item identifying barcode information, as described above in reference to FIG. 7, so that this information can be directly compared with the barcode data and manufacturer data in step 338. Alternately, the advertisement history data may include only alphanumeric values identifying the individual advertisements that have been presented, with the subroutine 326 determining barcode data and manufacturer data from the data records 198 within the data structure 67 matching the advertisements that have been presented.

If it is determined in step 342 that barcode data transmitted from a shopping cart 222 does not match the barcode information stored in the item data structure 66 of the store computer system 220, an error code is returned to the shopping cart 222 in step 342.

If it is determined in step 332 that the transmission from a shopping cart does not include barcode data, the subroutine 326 proceeds to step 344 to perform another function in response to the message.

In accordance with the invention, advertising messages may be played from computer readable instructions or from another video medium, such as videotape. Alternately, advertising messages may be static in nature, being printed on cards or placards, used as described below.

FIG. 13 is a front elevation of an alternative display unit 350, holding a pair of advertising placards 352, each of which has advertising material 354 printed on a front side 356. The placards 352 are held in grooved tracks 358 within the display unit 350, with the advertising material 354 being visible through slots. The display unit 350 additionally includes a number of electrical contacts 360 which are operated by contact with a pattern 362 of notches and tabs extending along an edge of each of the placards 352. The pattern 362 of notches and tabs is configured to identify the advertising material 354 printed on the placard 352. The display unit 350 may additionally include a detent spring 354 holding each of the placards 352 in place when it is fully inserted within one of the grooved tracks 358.

FIG. 14 is a block diagram of the display unit 350, as configured for use with a point-of-sale terminal 12 (shown in FIGS. 1 and 2). Output signals from the electrical contacts 360 are provided as inputs to an encoder 366, which generates an encoded output according to each combination of contact closures that can be established by a pattern 362 of tabs and notches in one of the placards 352. For two placards, as shown in the example of FIG. 13, two such encoded outputs are generated. Signals representing these encoded outputs are transmitted on a periodic basis through a transmitter 368.

Referring to FIGS. 2, 13, and 14, when a shopping cart including the alternative display unit 350 is brought into place adjacent the point-of-sale terminal 12 for the check-out process the transmitter 368 within the display unit 350 is brought into range of the transceiver 73, which may be simply a receiver in this application, within the point-of-sale terminal 12. The transmitter 368 periodically emits pulses generated according to the settings of contacts 360, indicating the content of the advertisements 354. The point-of-sale terminal 12 is programmed to receive these pulses and to transmit data following the first such pulse received during the check-out-process to the store computer system 10, which then compares this data with the items being checked out as described above in reference to FIG. 5.

Referring to FIGS. 10 and 13, the alternative display unit 350 may additionally be used with a shopping cart including a barcode reader for checking out items as they are placed within the cart. When this is done, the advertisement history data file 250 is not used, with its function being replaced by evaluating the output of the contacts 360 to determine the advertisement messages that have been presented. A display screen 236, which may be a small screen presenting a single line of data, is retained to provide for the presentation of data describing the items scanned and their prices.

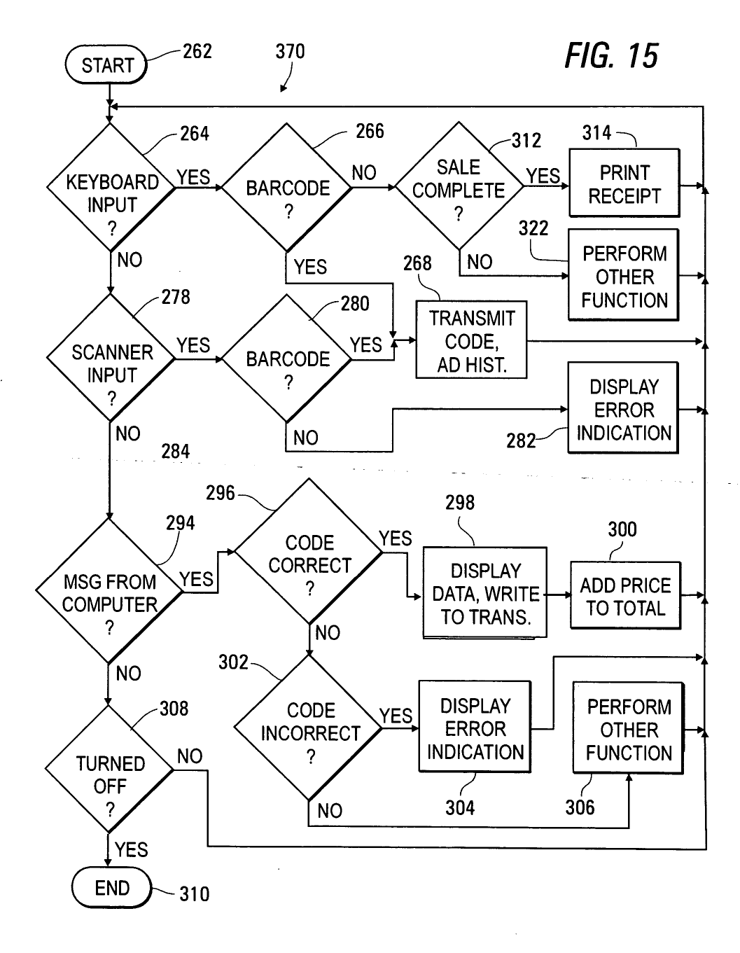

FIG. 15 is a flow chart of processes occurring during the execution of a subroutine 370 within a shopping cart 222 equipped with the alternative display nit 350. Individual process steps are as described above in reference to FIG. 11, and are therefore accorded like reference numerals. The process steps associated with the display of a message in step 274 and the process steps associated with the display of advertisements have been omitted from the subroutine 370. In step 268, the advertisement history is still transmitted to the store computer 220 along with a code representing a barcode, but the advertisement history is generated by examining the settings of contacts 360 instead of by reading a data file. Since the advertisements are constantly presented, being manually changed by substituting placards 352, it is not necessary to set and reset a latch. The operation of the store computer system 220 in response to data transmitted with this subroutine 370 is as described above in reference to FIG. 12.

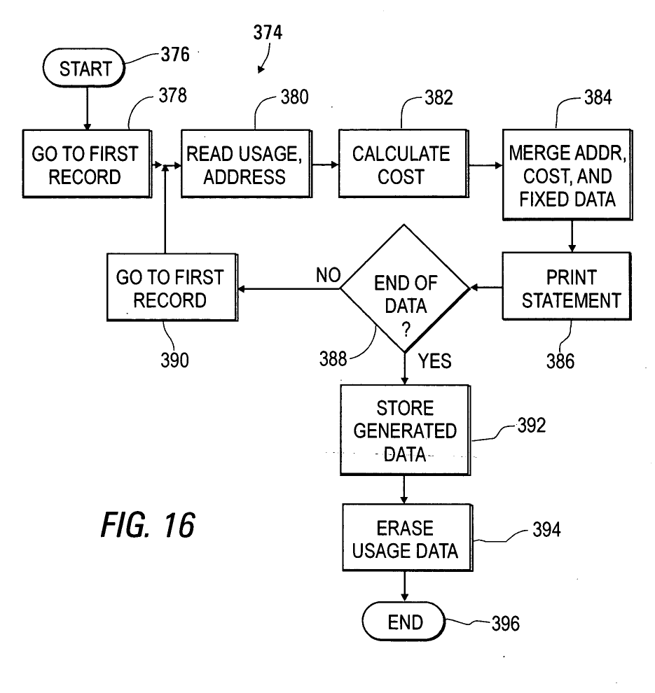

FIG. 16 is a flow chart of processes occurring within either the store computer system 10 of FIG. 1 or the store computer system 220 of FIG. 10 during execution of a subroutine 374 for printing statements to charge for presenting advertisements. Charges are made for each advertisement according to the number of times it was presented in a shopping cart 14, 222 during an individual use of the shopping cart 14, 222 before items associated with the advertisement were checked out using that particular shopping cart.

Referring to FIGS. 9 and 16, after starting in step 376 the subroutine 374 proceeds to examine the first data record 198 within the advertisement data structure 67. Then, in step 378, the usage number from the counting data field 200 and the address from the address data field 203 are read in step. Then, in step 382 a value for the cost of advertising is calculated from an algorithm, that, for example, charges a first amount per unit of time, together with a second amount for every time a product associated with the advertisement was purchased, as indicated by the value in the counting data field. The first amount may be set at a value of zero for an advertiser that is only charged for advertisements producing sales results. Next, in step 384, the address data read in step 380 is merged with the cost data calculated in step 382, and with fixed data to generate a statement, which is printed in step 386. Then, in step 233, a determination is made of whether the end of the data has been reached at the last data record 198. It it has not, the subroutine 374 proceeds to examine the next data record 198 in step 390, with this process being repeated until each data record 198 has been examined. Then, the generated data is stored in step 392, providing a record of accounts receivable and a record of the effectiveness of the advertising program. Next, in step 392, data within the counting data field 200 of the advertisement data structure 67, is erased, preparing the data structure 67 to receive new data. Then, the subroutine 374 ends in step 396.

While a method for generating statements within a single store computer system 10, 220 has been described, it is understood that a typical application may involve a number of store computer systems in different locations, with advertising usage data being pooled from various such systems before cost statements are generated.

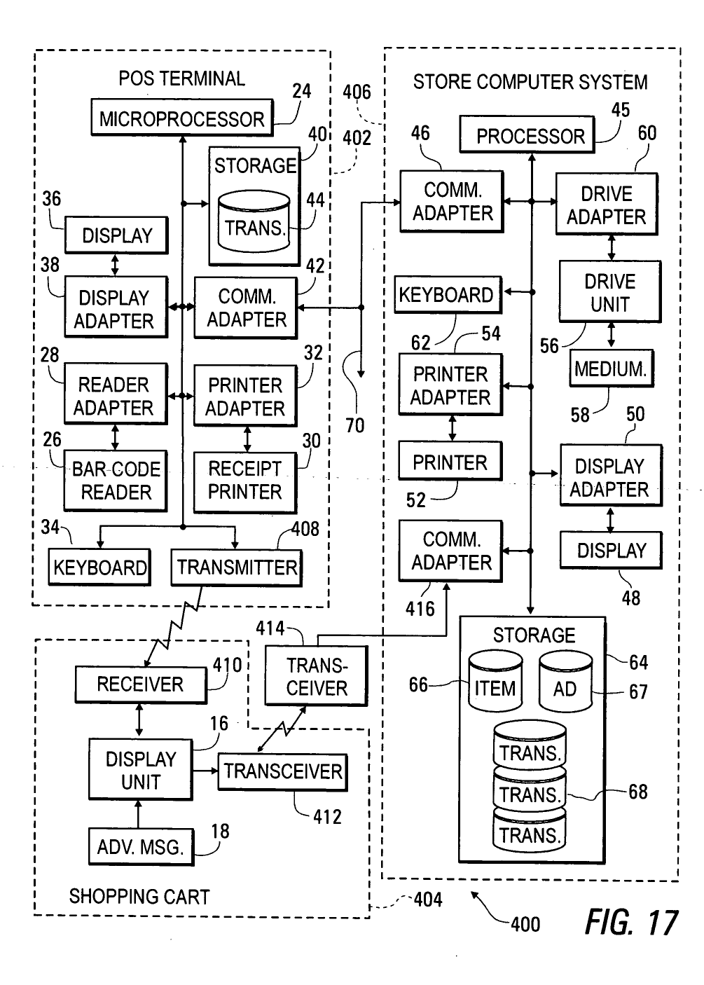

FIG. 17 is a block diagram of an alternative system 400 built in accordance with a second version of the first embodiment of the invention, having a number of components that are similar or identical to corresponding components in the system described above in reference to FIG. 1, which are therefore accorded like reference numbers. The alternative system 400 includes one or more point-of-sale terminals 402, a number of shopping carts 404 and a store computer system 406. In the point-of-sale terminal 402, transceiver 42 of the point-of-sale terminal 12 has been replaced with a transmitter 408, while in the shopping cart 404 the transceiver 22 of the shopping cart 14 has been replaced with a receiver 410. The shopping cart 404 of the alternative system 400 is additionally provided with a transceiver 412 transmitting data to a transceiver 414 connected to the store computer system 406 through a communication adapter 416.

The process steps occurring within the shopping cart 404 of the alternative system 400 are as described above in reference to FIG. 4, except that data is transmitted in step 110 to the store computer system 406 through the transmitter 412 within the shopping cart 404 instead of to the point-of-sale terminal. The beacon signal received in step 106 includes a code identifying 106 from the transmitter 408 within the point-of-sale terminal additionally includes a code identifying the particular point-of-sale terminal 402 among a number of such terminals within the store. Then, a code identifying the point-of-sale terminal 402 is transmitted with the advertisement history data in step 110.

The process steps occurring within the point-of-sale terminal 402 are as described above in reference to FIG. 5, except that, since an input from the shopping cart providing advertisement history data is no longer received, step 136 of determining whether such an input has occurred is eliminated, together with step 138 for receiving such data and step 140 for transmitting such data.

When the shopping cart 404 is in position adjacent the point-of-sale terminal 402, a beacon signal received in step 106 thus causes the shopping cart 404 to transmit advertisement history data, together with a code identifying the particular point-of-sale terminal 402 to the store computer system 406. Preferably, this data is transmitted only once, before the process of checking out items is begun. If the beacon signal is transmitted on a continuous or periodic basis, the process of erasing the advertisement history in step 114, followed by a subsequent determination in step 108 that there is no data in the advertisement history data structure, prevents an additional transmission of such data. Alternately, a command to transmit a beacon signal to start this data transmission process may be provided as an input at the point-of-sale terminal 402 before beginning the process or scanning barcodes to check out items.

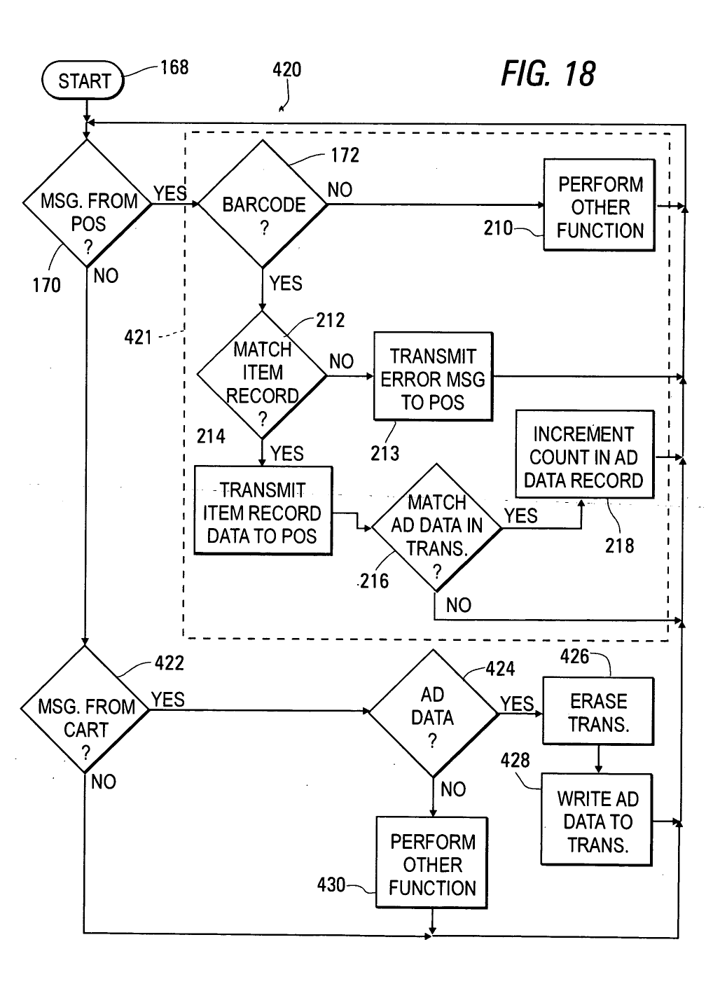

FIG. 18 is a flow chart of a subroutine 420 executing within the store computer system 406 of FIG. 17 during operation of the system 400. Many of these process steps, including a number of process steps included within dashed lines 421 are similar or identical to process steps explained above in reference to FIG. 6, and are therefore accorded like reference numbers. Within the subroutine 420, since the point-of-sale terminal 402 no longer transmits advertisement history data to the store computer system 406, when a message is received from the point-of-sale terminal, as determined in step 170. it must either be barcode data from scanning an item, as determined in step 172, or a command to perform another function in step 210. On the other hand, if a message is received from the shopping cart 404 through the transceiver 414, as determined in step 422, a further determination is made in step 424 of whether the message is advertisement history data being transmitted at the beginning of the process of checking out items. If it is, the transaction data structure 68 associated with the point-of-sale terminal 402 at which items will be checked out is erased in step 426, with the new advertisement history data then being recorded in this data structure in step 428. If it is determined in step 424 that the message from the cart is not advertising history data, the store computer system 406 performs another function as requested in step 430.

When the store computer system 406 is executing the subroutine 420 of FIG. 18, two way communications are not needed between the shopping cart 404 and the store computer 406. It is only necessary for the shopping cart 404 to be able to transmit advertising history data to the store computer system 406, so the transceiver 412 within the shopping cart 404 may be replaced with a transmitter, while the transceiver 414 attached to the store computer system 406 is replaced with a receiver.

Referring again to FIG. 17, data transmissions from the transceiver 414 of the store computer system 406 may alternately be used to initiate and control the presentation of advertising messages within the shopping cart 404. When this is done, it is unnecessary for the shopping cart to store and transmit advertisement history data. A record of all of the advertisements that have been presented is stored in a transaction data structure 68 for each of the shopping carts 404 being used.

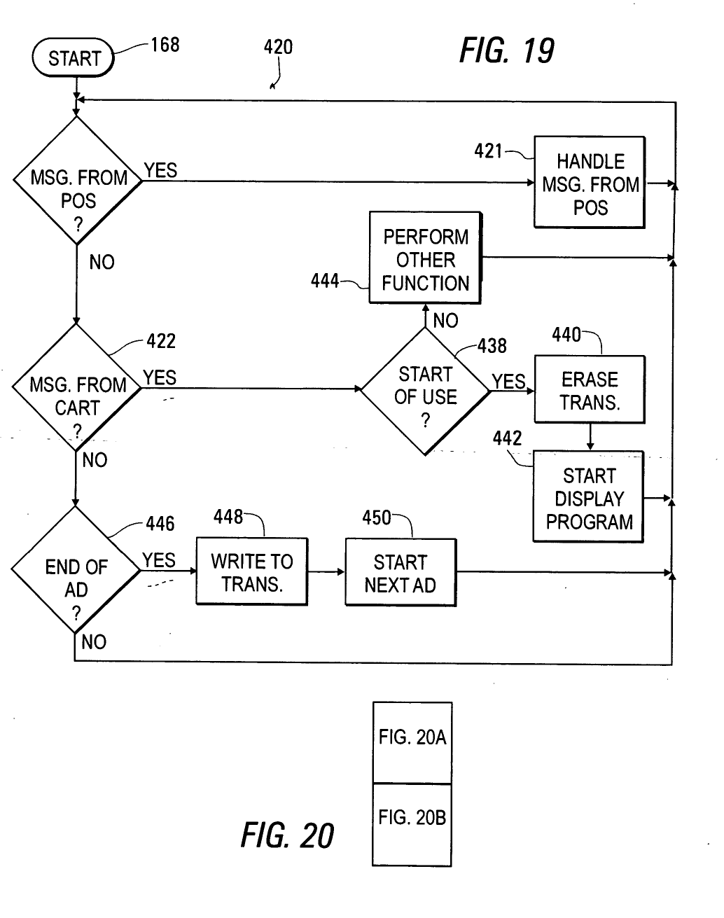

FIG. 19 is a flow chart of a subroutine 434 alternatively executing within the store computer system 406 to initiate and control the presentation of advertising messages within one or more of the shopping carts. Several of the process steps are similar or identical to process steps discussed above in reference to FIG. 18, and are therefore accorded like reference numbers. For example, when a determination is made in step 170 that a message has been received from the point-of-sale terminal 402, the various steps within dashed lines 421 (shown in FIG. 18) are employed to handle a message from the terminal 402.

Since each transaction data structure 68 now corresponds to an individual shopping cart 404 instead of to an individual point-of-sale terminal 402, the identity of the shopping cart 104 must be associated with the identity of the point-of-sale terminal 402 being used to check out items from a particular cart 404. For example, a code identifying the shopping cart 404 may be transmitted to the point-of-sale terminal 402 at the start of the check out process. Then, the point-of-sale terminal 402 transmits this information through its communications adapter 42 at the beginning of the check out process or with the barcode data transmitted for each item. Alternately, the point of said terminal may transmit a code identifying itself to the shopping cart 404, which then transmits this data along with a code representing the particular shopping cart 404 at the beginning of the check out process.

During execution of this subroutine 434, the display of advertisements within each shopping cart 404 is started after a determination in step 436 that a message has been received from the shopping cart 404, followed by a determination in step 438 that this transmission has been data indicating that a period of using the shopping cart 404 has begun. When it is determined that such a message has been received, data within the transaction data structure 68 associated with the particular shopping cart 404 transmitting the message is erased in step 440, so that data subsequently recorded in this data structure 68 only relates to the advertisements that have been presented in this period of use of the shopping cart 404. Then, in step 442, the display of advertising messages in the particular shopping cart 404 is begun. If it is determined in step 438 that a message received from a cart 404 is not an indication that a period of use of the cart has started, another function is performed in step 444.

When a determination is made in step 446 that a particular advertisement being displayed has ended, data identifying the advertisement is written in step 448 to each transaction file 68 associated with the one or more shopping carts 404 in which the advertisement has been displayed. Then in step 450, the process of displaying the next advertisement is begun.

The content of advertising messages may be stored within the individual shopping carts 404, with codes associated with the messages being transmitted from the transceiver 414 of the store computer system 406 to the transceiver 412 of the shopping cart. Alternately, the content of the advertisements may be stored within a file accessed by the store computer system 406, with content being transmitted from the transceiver 414 to the transceiver 412. Different advertising messages may be simultaneously presented within the various shopping carts 404, or the same advertising message may be simultaneously presented within all shopping carts 404, with the various transaction data structures 68 still being used to track the advertisements that have been presented within each period of use of each cart 404.

Referring again to FIG. 10, the store computer system 220 of a system operating in accordance with an alternative version of the second embodiment of the invention, additionally being provided with a capability to control the display of advertising messages within each of the shopping carts 222, with communications from the transceiver 252 of the store computer system 220 to the transceiver 242 of the shopping cart being shopping cart 222. The ad history data structure 250 within the shopping cart is eliminated, with data describing advertisements displayed in each of the shopping carts 222 during an individual period of use being instead stored within the transaction file 68 (shown in FIG. 1) of the store computer system 220 associated with the individual shopping cart 222.

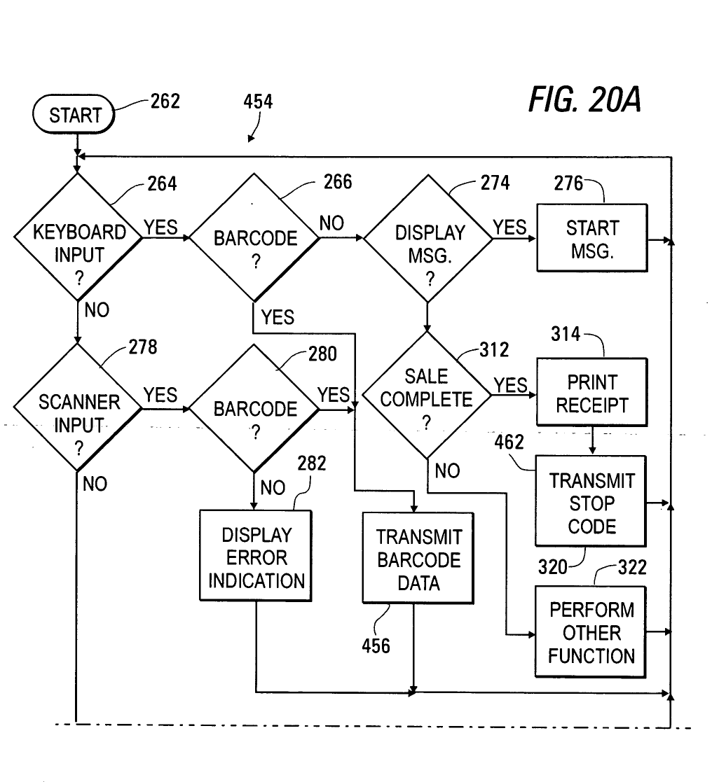

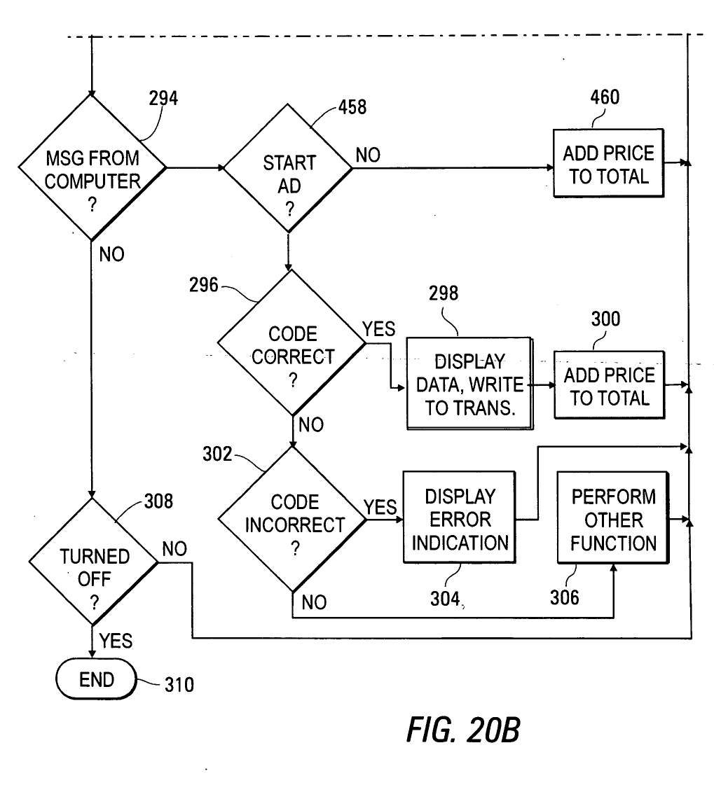

FIG. 20 is a flow chart of processes occurring within the shopping cart 222 of FIG. 10 during execution of a subroutine 454 within the microprocessor 224 in accordance with the alternative version of the second embodiment of the invention. FIG. 20 includes an upper portion, indicated as FIG. 20A, and a lower portion, indicated as FIG. 20B. The subroutine 454 provides for the presentation of advertisements under control of the store computer system 220 and for the communication of data derived from reading barcodes through the barcode reader 223 to the store computer system 220. The subroutine 454 includes a number of process steps that are similar or identical to process steps described above in reference to FIG. 11, which are therefore accorded like reference numbers.

In the example of FIG. 20, an ability of the shopping cart 222 to display a message selected by the shopper, starting in step 276 in response to the use of the keypad 234, is retained. Such a message may include instructions on the use of the features of the shopping cart 222.

The display of advertising messages is started under control of the store computer system 220 after an indication is received that the shopping cart is being used. For example, such an indication is provided by the first instance of barcode data being transmitted from the shopping cart 222 to the store computer system 220.

After a barcode is provided as an input, either through the barcode reader 223, as determined in step 266, or through the keypad 234, data representing the barcode is transmitted to the store computer in step 456.

When a message is received from the store computer system 220, a determination is made in step 458 of whether the message is a command to start the display of an individual advertisement. If it is, the process of displaying the advertisement requested is begun in step 460.

When an input is received from the keypad 234 indicating that the sale is complete, as determined in step 312, a receipt is printed in step 314. Then, in step 462, a stop code is transmitted to the store computer system 220 to stop the presentation of advertisements within the shopping cart 222.

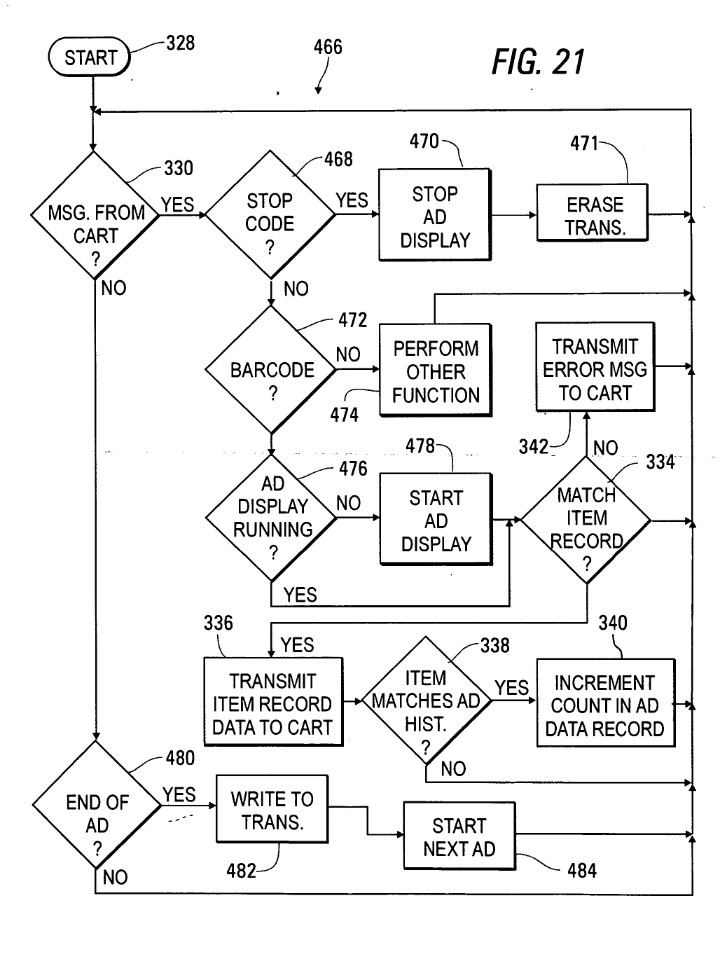

FIG. 21 is a flow chart of processes occurring in the store computer system 220 during execution of a subroutine 466 in accordance with the alternative version of the second embodiment of the present invention. A number of the process steps in the subroutine 466 are similar or identical to process steps described above in reference to FIG. 12 and are therefore accorded like reference numbers.

After a message is received from one of the shopping carts 222, as determined in step 330, a further determination is made in step 468 of whether the message contains a stop code transmitted from the shopping cart 222 in step 462 of FIG. 20. It is understood that each message received from a shopping cart 222 includes data identifying the particular cart 222 sending the message. If it does include a stop code, the process of displaying advertisements within that particular shopping cart 222 is stopped in step 470. Then, in step 471, the transaction data structure 68 shown in FIG. 1) associated with the particular shopping cart 222 is erased in preparation for receiving information during the next usage of the cart 222.

If the message does not contain a stop code, the subroutine 466 continues to step 472, in which a further determination is made of whether the message contains barcode data. If it does not, another function is performed as requested in step 474. If the message does contain barcode, a further determination is made in step 476 of whether a advertisement display is running in the shopping cart 222. If it is not running, the advertisement program is started in step 478. In either case, the subroutine 466 proceeds to step 334, in which a determination is made of whether the barcode data received matches data stored in the item data structure 66 (shown in FIG. 1). After determining that a data match is found in step 334, and after then transmitting item record data to the shopping cart 222 in step 336, a further determination is made of whether data describing the item scanned matches advertisement history data stored in the transaction data structure 68 (also shown in FIG. 1) associated with the particular shopping cart 222.

In step 480 a determination is made of whether the end of a period for displaying an advertisement within one of the shopping carts 222 has been reached. If it has, information identifying the advertisement that has been displayed is written to the transaction data file in step 482 adding to an advertisement history file storing information describing the advertisements that have been presented during the particular period of use of the shopping cart 222. Then, in step 484, the process of displaying the next advertisement is started.

While the preceding description has referred to barcodes and barcode readers or scanners, it is understood that such elements are meant to be merely examples of machine readable elements identifying items and sensing devices for generating data based on reading information from such machine readable elements. Other methods, such as the identification of radio frequency tags, as described in U.S. Pat. No. 5,729,697, the disclosure of which is incorporated herein by reference, may be used to derive item identification data as items are checked out at the point-of-sale terminal 12 or into a shopping cart 222 having an ability to generate data representing items as they are placed therein. Such alternate methods may be used to develop item identification codes or data without departing from the spirit and scope of the invention.

While the invention has been described in its preferred forms or embodiments with some degree of particularity, it is understood that this description has been given only by way of example, and that many variations can be made without departing from the spirit and scope of the invention, as described in the appended claims.

1. A method for measuring effectiveness of advertisements displayed on a shopping cart, wherein said method comprises:
a) displaying at least one advertisement on said shopping cart;
b) generating advertisement history data representing each of said at least one advertisement;
c) generating a code representing at least one item purchased by a shopper using said shopping cart;
d) comparing each said code representing at least one item with said advertisement history data to determine whether an item advertised in said at least one advertisement is purchased by said shopper using said shopping cart; and
e) generating usage data representing each display of an advertisement for an item purchased by said shopper using said shopping cart.

2. The method of claim 1, wherein
step a) includes displaying images generated from an electrical signal on a display screen, and
step b) includes storing a code representing each of said at least one advertisement in an advertisement history data stricture.

3. The method of claim 1, wherein
step a) includes holding at least one advertising placard within a display unit, and
step b) includes generating an electrical signal in accordance with settings of electrical contacts operated according to a pattern of a surface of said at least one advertising placard held within said display unit.

4. The method of claim 1, wherein
step c) includes reading a machine readable element identifying said at least one item with a sensing device at a point-of-sale terminal, and
said method additionally comprises transmitting said advertisement history data to said point-of sale terminal from said shopping cart adjacent said point-of-sale terminal.

5. The method of claim 4, wherein
said method additionally comprises transmitting said code representing said at least one item and said advertisement history data to a store computer system from said point of sale terminal, and
steps d) and e) are performed according to instructions executing within said store computer system.

6. The method of claim 4, wherein
step a) occurs during a period of use of said shopping cart by said shopper,
a beginning of said period of use is determined by sensing movement of said shopping cart, and
an end of said period of use is determined by transmitting said advertisement history data to said point-of-sale terminal.

7. The method of claim 4, wherein
step a) occurs during a period of use of said shopping cart by said shopper,
a beginning of said period of use is determined by sensing manual operation of a switch, and
an end of said period of use is determined by transmitting said advertisement history data to said point-of-sale terminal.

8. The method of claim 1, wherein
step c) includes reading a machine readable element identifying said at least one item with a sensing device attached to said shopping cart,
said method additionally comprises transmitting said code representing said at least one item and said advertisement history data to a store computer system from said shopping cart, and
steps d) and e) are performed according to instructions executing within said store computer system.

9. The method of claim 8, wherein
said shopping cart additionally includes a receipt printer,
step a) occurs during a period of use of said shopping cart by said shopper with said sensing device,
said period of use begins with reading said machine readable element of a first item;
said period of use ends with printing a receipt within said receipt printer.

10. The method of claim 1, wherein
step d) includes comparing a code representing at least one item with a data record representing at least one advertisement, and
said data record includes at least one code representing an item advertised in said advertisement represented by said data record.

11. The method of claim 10, wherein
said data record is generated within said shopping cart and transmitted to a store computer system; and
steps d) and e) are performed according to instructions executing within said store computer system.

12. The method of claim 10, wherein
said advertisement history data is generated within said shopping cart and transmitted to a store computer system,
said data record is generated within said store computer system by comparing said advertisement history data with an advertisement data structure including codes representing items advertised by a plurality of advertisements.

13. The method of claim 1, wherein step d) includes
determining a name associated with a code representing an item from an item data structure relating codes representing items with names associated with said items; and
comparing said name associated with said code with a data record representing an advertisement displayed on said shipping cart, wherein said data record includes a name advertised in said advertisement represented by said data record.

14. The method of claim 13, wherein
said data record is generated within said shopping cart and transmitted to a store computer system; and
steps d) and e) are performed according to instructions executing within said store computer system.

15. The method of claim 13, wherein
said advertisement history data is generated within said shopping cart and transmitted to a store computer system,
said data record is generated within said store computer system, and
steps d) and e) are performed according to instructions executing within said store computer system.

16. The method of claim 1, additionally comprising determining a plurality of amounts of money owed by a plurality of advertisers by applying an algorithm to said usage data.

17. The method of claim 1, wherein
step a) is controlled by executing instructions in a store computer system according to data transmitted from said store computing system to said shopping cart, and
said advertisement history data is generated and stored within said store computer system.

18. The method of claim 17, wherein
step c) includes reading a machine readable element identifying said at least one item with a sensing device at a point-of-sale terminal,
said method additionally comprises transmitting said code representing at least one item purchased by a shopper using said shopping cart from said point-of-sale terminal to said store computer system, and
steps d) and e) are performed according to instructions executing within said store computer system.

19. The method of claim 17, wherein
step c) includes reading a machine readable element identifying said at least one item with a sensing device attached to said shopping cart,
said method additionally comprises transmitting said code representing said at least one item to said store computer system from said shopping cart, and
steps d) and e) are performed according to instructions executing within said store computer system.

20. A system for displaying advertisements and for determining effectiveness of said advertisements, wherein said system comprises:
at least one shopping cart including a display unit for displaying advertisements, means for generating and storing advertisement history data representing advertisements displayed within said display unit, and a transmitter for transmitting said advertising history data;
at least one sensing device for generating item codes representing items having machine readable elements identifying said items; and
a store computer system including an item data structure storing codes representing a plurality of items, an advertisement data structure storing data representing advertisements, communication means for receiving said item codes and said advertisement history data, and a processor programmed to compare said item codes with said advertisement history data to determine weather an item advertised in an advertisement displayed in said at least one shopping cart has been purchased by said shopper, and to generate usage data representing each display of an advertisement for an item purchased by said shopper using said shopping cart.

21. The system of claim 20, additionally comprising at least one point-of-sale terminal and a communication channel extending between each said at least one point-of-sale terminal and said store computer system, wherein
each said sensing device is located at a point-of-sale terminal,
said transmitter transmits said advertisement history data to said point-of-sale terminal, and
each said at least one point-of-sale terminal transmits said advertisement history data and said item codes to said store computer system over said communication channel.

22. The system of claim 20, wherein
each of said transmitters is a portion of a transceiver,
each of said at least one point-of-sale terminals transmits a beacon signal, and
said transmitter transmits said advertisement history data to said point-of-sale terminal upon receiving said beacon signal at said transceiver.

23. The system of claim 20, wherein
each said sensing device is located in one of said at least one shopping cart, and
said transmitter transmits said advertisement data history and said idem codes to said store computer system.

24. The system of claim 20, wherein
said display unit includes a display screen displaying images generated from an electronic signal, and
said shopping cart includes storage including an advertisement history data structure holding said advertising history data.

25. The system of claim 20, wherein
said display unit comprises at least one slot for holding a placard having printed advertisement data and a plurality of switches activated by a element of surface structures on said placard, and
said advertisement history data is generated from outputs of said plurality of switches.

26. A system for displaying advertisements and for determining effictiveness of said advertisements, wherein said system comprises:
at least one shopping cart including a display unit for displaying advertisements and a receiver for receiving data causing said advertisements to be displayed;
at least one sensing device for generating item codes representing items having machine readable elements identifying said items; and
a store computer system including an item data structure storing codes representing a plurality of items, an advertisement data structure storing data representing advertisements, communication means for receiving said item codes and for transmitting said data causing said advertisements to be displayed in said display unit of each of said at least one shopping cart, a transaction data structure storing advertisement history data representing advertisements displayed within said display unit of each of said at least one shopping cart, and a processor programmed to generate said data causing said advertisements to be displayed in said display unit of each of said at least one shopping cart, to compare said item codes with said advertisement history data to determine weather an item advertised in an advertisement displayed in said at least one shopping cart has been purchased by said shopper, and to generate usage data representing each display of an advertisement for an item purchased by said shopper using said shopping cart.

27. The system of claim 26, additionally comprising at least one point-of-sale terminal and a communication channel extending between each said at least one point-of-sale terminal and said store computer system, wherein each said sensing device is located at a point-of-sale terminal transmitting said item codes to said store computer system.

28. The system of claim 26, wherein
each said sensing device is located in one of said at least one shopping cart, and
each said shopping cart transmits said item codes to said store computer system.

29. A method for displaying a plurality of advertisements within a shopping cart having a display screen and a microprocessor and for transmitting data indicating which advertisements have been displayed, wherein said method comprises
a) determining that a period of use of said shopping cart has begun;
b) displaying a series of advertisements within said plurality of advertisements on said display screen;
c) for each of said advertisements displayed, recording data identifying said advertisement in an advertisement history data structure;
d) transmitting data from said advertisement history data file;
e) determining that said period of use of said shopping cart has ended; and
f) stopping a display of said series of advertisements.

30. The method of claim 29, wherein
step a) includes determining that said shopping cart has been moved, and
a determination that said period of use of said shopping cart has ended is made in response to determining that a predetermined period of time has passed since a last movement of said shopping cart.

31. The method of claim 29, wherein
step a) includes determining that a switch on said shopping cart has been manually operated, and
a determination that said period of use of said shopping cart has ended is made in response to determining that a predetermined period of time has passed since a last movement of said shopping cart.

32. The method of claim 29, additionally comprising determining that said shopping cart has been moved into proximity with a point-of-sale terminal, wherein, in response to determining that said shopping cart has been moved into proximity with a point-of-sale terminal, said data from said advertisement history file is transmitted to said point-of-sale terminal in step d); and a determination that said period of use of said shopping cart has ended is made in step e).

33. The method of claim 29, wherein
step a) includes determining that a machine readable element identifying a first item has been read by a sensing device within said shopping cart, and
a determination that said period of time of said shopping cart use is made in step e) in response to a determination that a sales receipt is being printed by a receipt printer within said shopping cart.

34. The method of claim 29, wherein said data from said advertisement history file is transmitted in response to determining that a machine readable element identifying a first item has been read by a sensing device within said shopping cart.

35. A method performed within a computer system for determining how often advertisements are displayed in shopping carts used to purchase items advertised in said advertisements, wherein said method comprises:
a) receiving a code describing an item to be purchased;
b) determining that said item described by said code is advertised within an advertisement described by advertisement history data describing at least one advertisement displayed in a shopping cart; and
c) generating usage data indicating a display of said advertisement described by said advertising history data in a shopping cart used to purchased an item advertised within said advertisement.

36. The method of claim 35, wherein
said method additionally comprises receiving said advertisement history data in a first transmission from a point-of-sale terminal, and
said code is received in a transmission from said point-of-sale terminal following said first transmission.

37. The method of claim 35, wherein said code and said advertising history data are received together in a transmission from a shopping cart.

38. The method of claim 35, wherein step c) includes comparing said code with at least one code for an advertised item contained within said advertisement history data received in step b).

39. The method of claim 35, wherein step c) includes:
reading an advertisement data record from an advertisement data structure stored within said computer system for an advertisement described in said advertisement history data received in step b); and
comparing said code with one or more codes for advertised items contained within said advertisement data record.

40. The method of claim 35, wherein step c) includes:
reading an advertisement data record from an advertisement data structure stored within said computer system for an advertisement described in said advertisement history data received in step b);
reading an item data record from an item data structure stored within said computer system for an item identified by said code received in step a); and
comparing an advertised name read from said advertisement data record with a name associated with said item read from said item data record.

41. The method of claim 35, additionally comprising determining a plurality of amounts of money owed by a plurality of advertisers by applying an algorithm to said usage data.

42. The method of claim 35, additionally comprising
transmitting a code causing an advertisement to be displayed on said shopping cart, and
generating said advertising history data.

43. A computer readable medium having computer executable code causing a shopping cart having a display screen and a microprocessor to perform a method for displaying a plurality of advertisements within said shopping cart and for transmitting data indicating which advertisements have been displayed, wherein said method comprises
a) determining that a period of use of said shopping cart has begun;
b) displaying a series of advertisements within said plurality of advertisements on said display screen;
c) for each of said advertisements displayed, recording data identifying said advertisement in an advertisement history data structure;
d) transmitting data from said advertisement history data file;
e) determining that said period of use of said shopping cart has ended; and
f) stopping a display of said series of advertisements.

44. The computer readable medium of claim 43, wherein, within said method,
step a) includes determining that said shopping cart has been moved, and
a determination that said period of use of said shopping cart has ended is made in response to determining that a predetermined period of time has passed since a last movement of said shopping cart.

45. The computer readable medium of claim 43, wherein
said method additionally comprises determining that said shopping cart has been moved into proximity with a point-of-sale terminal, and,
within said method, in response to determining that said shopping cart has been moved into proximity with a point-of-sale terminal, said data from said advertisement history file is transmitted to said point-of-sale terminal in step d); and a determination that said period of use of said shopping cart has ended is made in step e).

46. The computer readable medium of claim 43, wherein, within said method,
step a) includes determining that a first item has been scanned by a barcode reader within said shopping cart, and
a determination that said period of time of said shopping cart use is made in step e) in response to a determination that a sales receipt is being printed by a receipt printer within said shopping cart.

47. The computer readable medium of claim 43, wherein, within said method, said data from said advertisement history file is transmitted in response to determining that an item has been scanned by a barcode reader within said shopping cart.

48. A computer readable medium having computer executable code causing a computer system to perform a method for determining how often advertisements are displayed in shopping carts used to purchase items advertised in said advertisements, wherein said method comprises:
a) receiving a code describing an item to be purchased;
b) determining that said item described by said code is advertised within an advertisement described by advertisement history data describing at least one advertisement displayed in a shopping cart; and
c) generating usage data indicating a display of said advertisement described by said advertising history data in a shopping cart used to purchased an item advertised within said advertisement.

49. The computer readable medium of claim 48, wherein
said method additionally comprises receiving said advertisement history data in a first transmission from a point-of-sale terminal, and
within said method, said code is received in a transmission from said point-of-sale terminal following said first transmission.

50. The computer readable medium of claim 48, wherein, within said method, said code and said advertising history data are received together in a transmission from a shopping cart.

51. The computer readable medium of claim 48, wherein, within said method, step c) includes comparing said code with at least one code for an advertised item contained within said advertisement history data received in step b).

52. The computer readable medium of claim 48, wherein, within said method, step c) includes:
reading an advertisement data record from an advertisement data structure stored within said computer system for an advertisement described in said advertisement history data received in step b); and
comparing said code with one or more codes for advertised items contained within said advertisement data record.

53. The computer readable medium of claim 48, wherein, within said method, step c) includes:
reading an advertisement data record from an advertisement data structure stored within said computer system for an advertisement described in said advertisement history data received in step b);
reading an item data record from an item data structure stored within said computer system for an item identified by said code received in step a); and
comparing an advertised name read from said advertisement data record with a name associated with said item read from said item data record.

54. The computer readable medium of claim 48, wherein said method additionally comprises determining a plurality of amounts of money owed by a plurality of advertisers by applying an algorithm to said usage data.

55. The computer readable medium of claim 48, wherein said method additionally comprises:
transmitting a code causing an advertisement to be displayed on said shopping cart; and
generating said advertising history data.

56. A computer data signal embodied in a carrier wave including computer executable code causing a shopping cart having a display screen and a microprocessor to perform a method for displaying a plurality of advertisements within said shopping cart and for transmitting data indicating which advertisements have been displayed, wherein said method comprises
a) determining that a period of use of said shopping cart has begun;
b) displaying a series of advertisements within said plurality of advertisements on said display screen;
c) for each of said advertisements displayed, recording data identifying said advertisement in an advertisement history data structure;
d) transmitting data from said advertisement history data file;
e) determining that said period of use of said shopping cart has ended; and
f) stopping a display of said series of advertisements.

57. The computer data signal of claim 56, wherein, within said method,
step a) includes determining that said shopping cart has been moved, and
a determination that said period of use of said shopping cart has ended is made in response to determining that a predetermined period of time has passed since a last movement of said shopping cart.

58. The computer data signal of claim 56, wherein
said method additionally comprises determining that said shopping cart has been moved into proximity with a point-of-sale terminal, and,
within said method, in response to determining that said shopping cart has been moved into proximity with a point-of-sale terminal, said data from said advertisement history file is transmitted to said point-of-sale terminal in step d); and a determination that said period of use of said shopping cart has ended is made in step e).

59. The computer data signal of claim 56, wherein, within said method,
step a) includes determining that a first item has been scanned by a barcode reader within said shopping cart, and
a determination that said period of time of said shopping cart use is made in step e) in response to a determination that a sales receipt is being printed by a receipt printer within said shopping cart.

60. The computer data signal of claim 56, wherein, within said method, said data from said advertisement history file is transmitted in response to determining that an item has been scanned by a barcode reader within said shopping cart.

61. A computer data signal embodied in a carrier wave including computer executable code causing a computer system to perform a method for determining how often advertisements are displayed in shopping carts used to purchase items advertised in said advertisements, wherein said method comprises:
a) receiving a code describing an item to be purchased;
b) determining that said item described by said code is advertised within an advertisement described by advertisement history data describing at least one advertisement displayed in a shopping cart; and
c) generating usage data indicating a display of said advertisement described by said advertising history data in a shopping cart used to purchased an item advertised within said advertisement.

62. The computer data signal of claim 45, wherein
said method additionally comprises receiving said advertisement history data in a first transmission from a point-of-sale terminal, and
within said method, said code is received in a transmission from said point-of-sale terminal following said first transmission.

63. The computer data signal of claim 61, wherein, within said method, said code and said advertising history data are received together in a transmission from a shopping cart.

64. The computer data signal of claim 61, wherein, within said method, step c) includes comparing said code with at least one code for an advertised item contained within said advertisement history data received in step b).

65. The computer data signal of claim 61, wherein, within said method, step c) includes:
reading an advertisement data record from an advertisement data structure stored within said computer system for an advertisement described in said advertisement history data received in step b); and
comparing said code with one or more codes for advertised items contained within said advertisement data record.

66. The computer data signal of claim 61, wherein, within said method, step c) includes:
reading an advertisement data record from an advertisement data structure stored within said computer system for an advertisement described in said advertisement history data received in step b);
reading an item data record from an item data structure stored within said computer system for an item identified by said code received in step a); and
comparing an advertised name read from said advertisement data record with a name associated with said item read from said item data record.

67. The computer data signal of claim 61, wherein said method additionally comprises determining a plurality of amounts of money owed by a plurality of advertisers by applying an algorithm to said usage data.

68. The computer data signal of claim 61, wherein said method additionally comprises:
transmitting a code causing an advertisement to be displayed on said shopping cart; and
generating said advertising history data.
